(19) United States
(12) Patent Application Publication
(10) Pub. No.: US 2026/0118793 A1
(43) Pub. Date: Apr. 30, 2026

(54) TONER

(71) Applicant: CANON KABUSHIKI KAISHA, Tokyo (JP)

(72) Inventors: SHOHEI KOTOTANI, Shizuoka (JP); MASATAKE TANAKA, Kanagawa (JP)

(21) Appl. No.: 19/360,789

(22) Filed: Oct. 16, 2025

(30) Foreign Application Priority Data
Oct. 25, 2024 (JP) 2024-188009

(51) Int. Cl. G03G 9/093; G03G 9/08

(52) U.S. Cl. CPC G03G 9/09342; G03G 9/0804

(57) ABSTRACT

A toner containing a toner particle. The toner particle has at a surface thereof a titanium oxide fine particle and a strontium titanate fine particle. The strontium titanate fine particle contains silicon. A content of the titanium oxide fine particle is 0.10 to 3.00 parts by mass with respect to 100 parts by mass of the toner particle. In a cross-sectional observation of the toner with a scanning transmission electron microscope, when a total area of the titanium oxide fine particle present on a contour of a cross section of the toner particle and within 30 nm inside the contour of the cross section of the toner particle is denoted by A, and a total area of the titanium oxide fine particle present outside the contour of the cross section of the toner particle is denoted by B, 1.00≥A/(A+B)≥0.50 is satisfied.

### BACKGROUND

### Field of the Technology

The present disclosure relates to a toner.

### Description of the Related Art

Methods for visualizing image information via an electrostatic latent image, such as electrophotography, electrostatic recording, and toner j et recording, have been applied to electrophotographic devices such as copiers, multifunction machines, and printers. In recent years, as the purpose and environment of use have become more diverse, a demand has been growing for such electrophotographic devices to be faster and have a longer life. In particular, with the worldwide spread of electrophotography, a demand has been growing for toners that can ensure sufficient charge quantity even in high-humidity environments, which are more disadvantageous to charging performance.

In high-humidity environments, it is difficult to increase the charge quantity of the toner due to the influence of the moisture content in the air, and moreover, charge retention property is degraded and charge distribution is likely to become broad due to charge leakage. In the development process in which toner is carried and developed onto an electrophotographic photosensitive member, if there is a toner with an insufficient charge quantity or a toner with a broad charge distribution, the toner may be developed on an unintended non-developed region. When this phenomenon occurs, the toner is printed on the margins of the paper, which are not originally intended to be developed, and high-quality images cannot be obtained. Therefore, a toner having a high charge quantity and a sharp charge distribution even in a high-humidity environment is required.

In order to control the charge quantity and other charging characteristics of the toner, a method of coating the toner surface with inorganic fine particles such as silica fine particles and titanium oxide fine particles, or organic fine particles such as silicone particles, has been used.

Japanese Patent Laid-Open No. 2020-109501 discloses a toner that is less likely to deteriorate in transferability even when used for a long period of time under high-temperature and high-humidity conditions as a result of arranging fine particles having a controlled volume resistance value at the surface of the toner particle and using silicone fine particles as an external additive.

In a high-temperature and high-humidity environment, charge leakage due to humidity is likely to occur, so a toner with a better charge retention property is required. In order to improve the charge retention property of the toner, a method can be considered in which the toner is configured such that the charge is unlikely to leak after charging, that is, such that the charge transfer between the toner and external additives or electrophotographic members is unlikely to occur. However, making it difficult for the toner to transfer charge means that it takes a longer time for the charge of the toner to saturate. Therefore, in a longer-life and higher-speed electrophotographic process, it is difficult to achieve both a high charge rising performance and properties such as high charge quantity and sharp charge distribution, especially in a high-temperature and high-humidity environment, and it has been found that there is room for further improvement.

### SUMMARY

According to the present disclosure, a toner is provided that has high charge retention property and sharp charging characteristics even in a high-temperature and high-humidity environment, and can maintain a high charge rising performance even in a longer-life and higher-speed electrophotographic process.

The present disclosure relates to a toner comprising a toner particle, wherein the toner particle has at a surface thereof a titanium oxide fine particle and a strontium titanate fine particle, the strontium titanate fine particle contains silicon, a content of the titanium oxide fine particle is 0.10 to 3.00 parts by mass with respect to 100 parts by mass of the toner particle, and in cross-sectional observation of the toner with a scanning transmission electron microscope, when a total area of the titanium oxide fine particle present on a contour of a cross section of the toner particle and within 30 nm inside the contour of the cross section of the toner particle is denoted by A (pixel), and a total area of the titanium oxide fine particle present outside the contour of the cross section of the toner particle is denoted by B (pixel), a formula (1) below is satisfied: 1.00≥A/(A+B)≥0.50 . . . (1).

Features of the present disclosure will become apparent from the following description of embodiments with reference to the attached drawings. The following description of embodiments is described by way of example.

### BRIEF DESCRIPTION OF THE DRAWINGS

FIG. 1 is an explanatory diagram showing a cross section of a cut thin sample.

FIGS. 2A and 2B are schematic diagrams of a powder resistivity measuring device.

FIG. 3 is a schematic diagram of a Faraday cage.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

In the present disclosure, “(meta)acrylic” means “acrylic” and/or “methacrylic.”

The present inventors conducted extensive research aimed at achieving both a high charge rising performance and such properties as high charge quantity and sharp charge distribution in a long-life and high-speed electrophotographic process in a high-temperature and high-humidity environment, and as a result, they discovered a toner configuration that can solve the above-mentioned disadvantages.

That is, a toner according to the present disclosure has a toner particle, wherein the toner particle has at the surface a titanium oxide fine particle and a strontium titanate fine particle, the strontium titanate fine particle contains silicon, the content of the titanium oxide fine particles is from 0.10 parts by mass to 3.00 parts by mass per 100 parts by mass of the toner particle, and in cross-sectional observation of the toner with a scanning transmission electron microscope, when a total area of the titanium oxide fine particle present on a contour of a cross section of the toner particle and within 30 nm inside the contour of the cross section of the toner particle is denoted by A (pixel), and a total area of the titanium oxide fine particle present outside the contour of the cross section of the toner particle is denoted by B (pixel), a formula (1) below is satisfied.

$$1. \geq A / ( A + B ) \geq 0.50 \qquad ( 1 )$$

Titanium oxide fine particles and strontium titanate fine particles are generally known to be usable as low-resistance external additives, and because of low resistance thereof, they excel in charge transfer with toner, thereby making it possible to improve the charge rising performance. Meanwhile, because of the low resistance, charge leakage is likely to occur, making it difficult to ensure a high charge quantity.

In response to this, the present inventors have discovered that by appropriately controlling A/(A+B) and appropriately embedding the titanium oxide fine particles in the toner surface, as in the configuration according to the present disclosure, it is possible to limit the areas where charge can be transferred, and to suppress charge leakage.

The present inventors have also discovered that by using silicon-containing strontium titanate fine particles as an external additive responsible for imparting charge, in addition to controlling the embedding degree of the titanium oxide fine particles, it is possible to ensure a high charge quantity and sharp charging characteristics. The present inventors speculate on the reason for this as follows.

It is known that strontium titanate fine particles can be used as an external additive with low resistance, similar to titanium oxide fine particles. Therefore, when ordinary strontium titanate fine particles are used, it is considered that electric charge leaks from the titanium oxide fine particles through the strontium titanate fine particles and a high charge quantity is difficult to ensure.

Meanwhile, it is considered that when silicon-containing strontium titanate fine particles are used, the strontium titanate fine particles contain silicon as an impurity within the crystal structure and are prone to lattice defects. When impurities or lattice defects are present within the crystal structure, these parts are generally likely to capture electrons or holes and are considered to function as sites for trapping electric charge, so it is considered that electric charge is easily retained, and a high charge quantity and sharp charging characteristics can be ensured.

Furthermore, it was found that because of the above-mentioned configuration, the toner has high flowability and high charge rising performance even in a long-life and high-speed electrophotographic process in a high-temperature and high-humidity environment.

Since strontium titanate fine particles are known as a hard external additive, there is a concern that such particles may be embedded in the toner in a high-temperature and high-humidity environment. However, with the above-mentioned configuration, the hard titanium oxide fine particles are appropriately embedded in the toner surface. Therefore, the titanium oxide fine particles act as a cushion to prevent the strontium titanate fine particles from being embedded in the toner even in a long-life process in a high-temperature and high-humidity environment. This allows the strontium titanate fine particles to move fluidly without being embedded in the toner. As a result, it is believed that the flowability of the toner can be maintained at a high level, and it is possible to suppress the occurrence of image defects associated with a decrease in flowability. Furthermore, it is speculated that because the toner can maintain high flowability throughout the life thereof, the opportunities for contact between the silicon-containing strontium titanate fine particles, which are likely to retain the electric charge, and the titanium oxide fine particles are increased, and charge rising performance is demonstrated.

Since the basic crystal structure of silicon-containing strontium titanate fine particles is strontium titanate, although the particles have sites that trap electric charge, they also have a low resistance characteristic, which is a specific feature of strontium titanate, and therefore it is believed that electric charge can be transferred quickly. Meanwhile, since titanium oxide fine particles are embedded, the sites for transferring charge are limited, but it is believed that once titanium oxide fine particles come into contact with strontium titanate fine particles, charge can be transferred quickly because fine particles of both types are low-resistance external additives. It is also speculated that because titanium oxide fine particles are embedded, charge can be delivered quickly to the toner particle. It is believed that the high flowability of strontium titanate fine particles contributes to the increased opportunities for contact between titanium oxide fine particles and strontium titanate fine particles, and it is speculated that the ability to maintain high flowability throughout the life of the toner allows the toner to have high charge rising performance throughout the life thereof.

Below, a preferred embodiment of the present disclosure will be described based on the abovementioned mechanism.

### Toner

The components that can constitute the toner and a method for producing the toner are explained hereinbelow.

The toner according to the present disclosure has a toner particle, wherein the toner particle has at the surface a titanium oxide fine particle and a strontium titanate fine particle, the strontium titanate fine particle contains silicon, the content of the titanium oxide fine particle is from 0.10 parts by mass to 3.00 parts by mass per 100 parts by mass of the toner particle, and in cross-sectional observation of the toner with a scanning transmission electron microscope, when a total area of the titanium oxide fine particle present on a contour of a cross section of the toner particle and within 30 nm inside the contour of the cross section of the toner particle is denoted by A (pixel), and a total area of the titanium oxide fine particle present outside the contour of the cross section of the toner particle is denoted by B (pixel), a formula (1) below is satisfied.

$$1. \geq A / ( A + B ) \geq 0 \text{.50} \qquad ( 1 )$$

The toner of the present disclosure is characterized in that the toner particle contains strontium titanate fine particles at the surface, and the strontium titanate fine particle contains silicon. The amount of silicon contained in the strontium titanate fine particle is preferably such that the ratio (Si/Sr) of the total mass of silicon atoms to the total mass of strontium atoms, as measured by X-ray fluorescence analysis, is from 0.20 to 0.60.

Where (Si/Sr) is at least 0.20, sufficient silicon is contained to trap charges while maintaining the low resistance characteristic of strontium titanate, so that a high charge quantity and appropriate charge transferability can be ensured. Meanwhile, where (Si/Sr) is not more than 0.60, the charging performance is properly maintained, so that the decrease in flowability due to electrostatic aggregation caused by overcharging is suppressed, and the charge rising performance is good. (Si/Sr) is preferably from 0.26 to 0.60, and more preferably from 0.26 to 0.50. (Si/Sr) can be controlled by the amount of silicon added during the production of the titanium strontium fine particles, the added material, the timing of addition, etc.

The content of the strontium titanate fine particles is preferably 0.10 parts by mass to 2.50 parts by mass, more preferably 0.10 parts by mass to 1.50 parts by mass, and even more preferably 0.5 parts by mass to 1.50 parts by mass, relative to 100 parts by mass of toner particle. If the content is at least 0.10 parts by mass, the charge quantity can be sufficiently ensured, and if it is not more than 2.50 parts by mass, the decrease in flowability due to electrostatic aggregation accompanying overcharging is suppressed, and the charge rising performance is good.

The number-average particle diameter of the primary particles of the strontium titanate fine particles is preferably 10 nm to 120 nm, and more preferably 25 nm to 80 nm. If the number-average particle diameter is at least 10 nm, overcharging is less likely to occur, and the charge distribution is likely to be sharper. If the number-average particle diameter is not more than 120 nm, the flowability is good, and the rise-up of charging of the toner is faster.

The powder resistivity R_{A} of the strontium titanate fine particles is, for example, 7.0×10⁷ μΩ·cm to 7.0×10¹² μΩ·cm, preferably 1.0×10⁸ μΩ·cm to 1.0×10¹² μΩ·cm, and more preferably 1.0×10⁹ to 1.0×10¹² μΩ·cm. When the R_{A} is at least 1.0×10⁷ μΩ·cm, the charge retention is sufficient, so that a high charge quantity can be ensured, and when the R_{A} is not more than 7.0×10¹² μΩ·cm, the sufficient charge transferability can be ensured, so that the charge rising performance of the toner is good. The powder resistivity R_{A} of the strontium titanate fine particles can be controlled by the particle diameter of the strontium titanate fine particles, the amount of silicon added during production, the type and content of the surface treatment agent, etc.

Furthermore, the toner of the present disclosure is characterized in that the toner particle contains titanium oxide fine particles at the surface. The content of titanium oxide fine particles is from 0.10 parts by mass to 3.00 parts by mass per 100 parts by mass of the toner particle. Where the content of titanium oxide fine particles is at least 0.10 parts by mass, the charge transferability is high, so the charge distribution is likely to be sharp, and the strontium titanate fine particles are also prevented from being embedded, so that the flowability and charge rising performance can be maintained throughout the life of the toner. Meanwhile, where the content of titanium oxide fine particles is not more than 3.00 parts by mass, the amount of titanium oxide fine particles is not excessive, so that charge leakage is unlikely to occur, and a high charge quantity can be ensured. More preferably, the content is from 0.10 parts by mass to 1.50 parts by mass, even more preferably from 0.10 parts by mass to 1.00 parts by mass, and particularly preferably from 0.50 parts by mass to 1.00 parts by mass.

Furthermore, in cross-sectional observation of the toner with a scanning transmission electron microscope, where a total area of the titanium oxide fine particles present on the contour of the cross section of the toner particle and within 30 nm inside the contour of the cross section of the toner particle is denoted by A (pixels), and a total area of the titanium oxide fine particles present outside the contour of the cross section of the toner particle is denoted by B (pixels), a formula (1) below is satisfied.

$$1. \geq A / ( A + B ) \geq 0 \text{.50} \qquad ( 1 )$$

In this case, A+B (pixels) represents the total area of the titanium oxide fine particles in the region to be observed. Also, A/(A+B) represents the proportion of the area where the titanium oxide fine particles are embedded in the toner particle out of the total area. Where A/(A+B) is at least 0.50, the proportion of the titanium oxide fine particles present outside the contour of the toner particle is small, so the region where charge can be transferred is not too large and charge is unlikely to leak. As a result, a high charge quantity can be ensured.

Meanwhile, since it is preferable that the titanium oxide fine particles be exposed to the outside in an appropriate range for the transfer of electric charge, where A/(A+B) is not more than 1.00, high charge rising performance is obtained.

A/(A+B) is more preferably from 0.50 to 0.95, and even more preferably from 0.60 to 0.90. A/(A+B) can be controlled by the external addition conditions of the titanium oxide fine particles and the number-average particle diameter of the primary particles. Specific measurement and adjustment methods will be described hereinbelow.

Furthermore, when the standard deviation of A/(A+B) is denoted by C, it is preferable that the formula (2) below be satisfied.

$$0.22 \geq C / \{ A / ( A + B ) \} \geq 0.00 \qquad ( 2 )$$

The standard deviation C means the variation in the embedding mode of the titanium oxide fine particles in the toner surface for each observation field. From the viewpoint that it is preferable that the titanium oxide fine particles be embedded uniformly in the toner surface, it is preferable that the standard deviation C be small. The standard deviation C is preferably in the range of 0.00 to 0.20, more preferably 0.00 to 0.15, and even more preferably 0.00 to 0.10.

C1{A/(A+B)} is an index expressing the variation taking into account the embedding rate of the titanium oxide fine particles. When A/(A+B) is large, that is, when the titanium oxide fine particles are embedded in a large amount, the titanium oxide fine particles are embedded evenly in the toner surface, so that the effect of the present disclosure is more likely to be exhibited. When A/(A+B) is large, even if the standard deviation C, that is, the difference in the embedding mode at each location on the toner surface, is large, the variation is in the region where the embedding rate is high, so it is assumed that the effect of the present disclosure, particularly the effect of high flowability, is likely to be exhibited. Meanwhile, where A/(A+B) is small, the variation is in the region where the embedding rate is low, so it is assumed that the effect of the present disclosure, particularly the effect of high flowability, is less likely to be exhibited unless the standard deviation C is small. For this reason, it is believed that the effect of the present disclosure is more likely to be exhibited when C/{A/(A+B)}, which is an index of variation taking into account the embedding rate, is in an appropriate range.

C/{A/(A+B)} is preferably from 0.00 to 0.22, more preferably from 0.00 to 0.20, and even more preferably from 0.00 to 0.15.

The number-average particle diameter of the primary particles of the titanium oxide fine particles is preferably from 5 nm to 50 nm, more preferably from 5 nm to 25 nm. By setting the particle diameter within the above range, it is easy to control A/(A+B), and the charge transfer is likely to be appropriately performed.

The dispersion evaluation index of the titanium oxide fine particles at the toner surface is preferably not more than 0.4, more preferably not more than 0.3. There is no particular lower limit, but it is preferably at least 0.0. Within the above range, the titanium oxide fine particles are uniformly arranged over the entire toner surface, so that charge transfer is easily performed properly, and furthermore, the strontium titanate fine particles are likely to be prevented from embedding, so that the flowability is unlikely to decrease. The dispersion evaluation index of the titanium oxide fine particles can be controlled by the external addition conditions and the amount of titanium oxide fine particles added. Specific measurement and adjustment methods will be described hereinbelow.

The powder resistivity R_{B} of the titanium oxide fine particles is preferably from 5.0×10⁵ μΩ·cm to 1.0×10¹⁰ μΩ·cm. Where R_{B} is at least 5.0×10⁵ μΩ·cm, the conductivity is not too high, so that charge leakage is unlikely to occur, and a high charge quantity can be ensured. Where R_{B} is not more than 1.0¹⁰ μΩ·cm, charge transfer between the titanium oxide fine particles and the toner particles and strontium titanate fine particles is easily performed quickly, and the charge rising performance is improved. R_{B} is preferably 1.0×10⁶ μΩ·cm to 7.0×10⁹ μΩ·cm, and more preferably 1.0×10⁷ μΩ·cm to 7.0×10⁸ μΩ·cm. R_{B} can be controlled by the baking temperature and the amount of surface treatment agent when producing the titanium oxide fine particles.

Needle-shaped titanium oxide fine particles are preferably used as the titanium oxide fine particles from the viewpoint of ease of embedding in the toner surface.

The titanium oxide fine particles are preferably rutile-type titanium oxide fine particles from the viewpoint of ease of forming needle-shaped particles due to the crystal structure thereof.

Furthermore, where the water washing method adhesion rate of the strontium titanate fine particles is denoted by α and the water washing method adhesion rate of the titanium oxide fine particles is denoted by β, it is preferable that β be from 40% to 100%, and α and β satisfy the relationship α≤β. The above means that the strontium titanate fine particles are more likely to move fluidly at the toner surface than the titanium oxide fine particles. In this case, the titanium oxide fine particles that are responsible for the transfer of charge on the toner surface are fixed to the toner surface, and the titanium oxide fine particles that hold the charge are rubbed between toner particles, achieving a state in which the titanium oxide fine particles are easily charged by friction, thereby making it easier to ensure a high charge quantity and to improve the charge rising performance. The water washing method adhesion rate α of the strontium titanate fine particles is preferably from 0% to 70%, more preferably from 0% to 60%, and even more preferably from 0% to 40%. The water washing method adhesion rate β of the titanium oxide fine particles is preferably from 40% to 100%, more preferably from 50% to 100%, and even more preferably from 60% to 100% or less. From the same viewpoint, it is preferable that a/β satisfies the relationship of the formula (3) below.

$$0.75 \geq α / β \geq 0 \text{.00} \qquad ( 3 )$$

The value of a/β is more preferably 0.10 to 0.50, and even more preferably 0.20 to 0.40. α and β can be controlled by adjusting the external addition conditions of each fine particle type. Examples include changing the external coating method (dry, wet, etc.), the rotation speed of an external addition blade, and an external addition time.

The materials constituting the toner and the method for producing the toner are described in more detail hereinbelow.

The toner has a toner particle. The toner particle preferably contains a binder resin. The content of the binder resin is preferably at least 50% by mass, and more preferably at least 75% by mass, based on the total amount of resin components in the toner particle. There is no particular upper limit, and the content of the binder resin may be 50% by mass to 100% by mass, 75% by mass to 100% by mass, or 75% by mass to 90% by mass, based on the total amount of resin components in the toner particle.

The binder resin is not particularly limited, and examples thereof include styrene acrylic resin, epoxy resin, polyester resin, polyurethane resin, polyamide resin, cellulose resin, polyether resin, mixed resins or composite resins thereof. Styrene acrylic resin and polyester resin are preferred because they are inexpensive, easily available, and excel in low-temperature fixability.

Examples of styrene acrylic resin include polymers composed of the following monofunctional or polyfunctional polymerizable monomers, copolymers obtained by combining at least two of these, and mixtures thereof.

Examples of monofunctional polymerizable monomers include the following.

Styrene; styrene derivatives such as α-methyl styrene, β-methyl styrene, o-methylstyrene, m-methyl styrene, p-methyl styrene, 2,4-dimethyl styrene, p-n-butyl styrene, p-tert-butyl styrene, p-n-hexyl styrene, p-n-octyl styrene, p-n-nonyl styrene, p-n-decylstyrene, p-n-dodecylstyrene, p-methoxystyrene, and p-phenyl styrene; acrylic polymerizable monomers such as methyl acrylate, ethyl acrylate, n-propyl acrylate, iso propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyl oxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters such as vinyl acetate, vinyl propionate, vinyl butyrate, vinyl benzoate, and vinyl formate; vinyl ethers such as vinyl methyl ether, vinyl ethyl ether, and vinyl isobutyl ether; vinyl ketones such as vinyl methyl ketone, vinyl hexyl ketone, and vinyl isopropyl ketone.

Examples of polyfunctional polymerizable monomers include the following.

Diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxy-diethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy-diethoxy)phenyl)propane, 2,2′-bis(4-(methacryloxy-polyethoxy)phenyl)propane, trimethylolpropane trimethacrylate, tetramethylolmethane tetramethacrylate, divinylbenzene, divinylnaphthalene, and divinyl ether.

Polyester resins that can be used are those obtained by condensation polymerization of carboxylic acid components and alcohol components listed hereinbelow. Examples of carboxylic acid components include terephthalic acid, isophthalic acid, phthalic acid, fumaric acid, maleic acid, cyclohexanedicarboxylic acid, and trimellitic acid. Examples of alcohol components include bisphenol A, hydrogenated bisphenol, ethylene oxide adduct of bisphenol A, propylene oxide adduct of bisphenol A, glycerin, trimethylolpropane, and pentaerythritol.

The polyester resin may be a polyester resin containing a urea group. It is preferable that the carboxyl groups at the terminals etc. of the polyester resin be not capped.

The toner particle may contain a colorant. Known pigments and dyes can be used as the colorant. Pigments are preferred as the colorant because of excellent weather resistance thereof.

Examples of cyan colorants include copper phthalocyanine compounds and derivatives thereof, anthraquinone compounds, and basic dye lake compounds.

Specific examples include the following: C. I. Pigment Blue 1, 7, 15, 15:1, 15:2, 15:3, 15:4, 60, 62, and 66.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples include the following: C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C. I. Pigment Violet 19.

Examples of yellow colorants include condensed azo compounds, isoindolinone compounds, anthraquinone compounds, azo metal complexes, methine compounds, and allylamide compounds.

Specific examples include the following: C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants include carbon black and those toned to black using the abovementioned yellow colorants, magenta colorants, and cyan colorants.

These colorants can be used alone or in a mixture, or in the form of a solid solution.

The colorant is preferably used in an amount of 1.0 parts by mass to 20.0 parts by mass per 100.0 parts by mass of the binder resin.

The toner can also be made magnetic by including a magnetic body.

In this case, the magnetic body can also function as a colorant.

The magnetic body can be an iron oxide such as magnetite, hematite, and ferrite; a metal such as iron, cobalt, and nickel; or an alloy of these metals with metals such as aluminum, cobalt, copper, lead, magnesium, tin, zinc, antimony, beryllium, bismuth, cadmium, calcium, manganese, selenium, titanium, tungsten, and vanadium, and mixtures thereof.

The toner particle may contain a release agent. As the release agent, a conventionally known wax may be used without any particular restrictions. Specific examples include the following.

Paraffin waxes, microcrystalline waxes, petroleum waxes and derivatives thereof, such as petrolatum, montan wax and derivatives thereof, hydrocarbon waxes produced by the Fischer-Tropsch process and derivatives thereof, polyolefin waxes represented by polyethylene and derivatives thereof, natural waxes represented by carnauba wax and candelilla wax and derivatives thereof.

These derivatives include oxides, block copolymers with vinyl monomers, and graft modified products.

Furthermore, alcohols such as higher aliphatic alcohols, fatty acids such as stearic acid and palmitic acid or acid amides, esters, and ketones thereof, hydrogenated castor oil and derivatives thereof, vegetable waxes, and animal waxes can be used. These can be used alone or in combination.

Among these, polyolefins, hydrocarbon waxes produced by the Fischer-Tropsch process, and petroleum waxes are preferred, as they tend to improve the developing performance and transferability.

Antioxidants may be added to these waxes to the extent that the above effects are not affected.

The content of the release agent is preferably from 1.0 part by mass to 30.0 parts by mass relative to 100.0 parts by mass of the binder resin or the polymerizable monomer that forms the binder resin.

The melting point of the release agent is preferably from 30° C. to 120° C., more preferably from 60° C. to 100° C.

By using a release agent that exhibits the above-mentioned thermal characteristics, the release effect is efficiently expressed and a wider fixing region is ensured.

Various organic or inorganic fine powders may be added, as necessary, to the toner particles as external additives, within a range in which the effects of the present disclosure are not impaired. The organic or inorganic fine powder preferably has a particle diameter of not more than 1/10 of the weight-average particle diameter of the toner particles from the viewpoint of durability when added to the toner particles.

Examples of organic or inorganic fine powders that can be used include the following.
(1) Fluidity-imparting agents: silica, alumina, titanium oxide, carbon black, and carbon fluoride.
(2) Abrasives: metal oxides (e.g., strontium titanate, cerium oxide, alumina, magnesium oxide, and chromium oxide), nitrides (e.g., silicon nitride), carbides (e.g., silicon carbide), and metal salts (e.g., calcium sulfate, barium sulfate, and calcium carbonate).
(3) Lubricants: fluororesin powders (e.g., vinylidene fluoride and polytetrafluoroethylene), and fatty acid metal salts (e.g., zinc stearate and calcium stearate).
(4) Charge-controlling particles: metal oxides (e.g., tin oxide, titanium oxide, zinc oxide, silica, and alumina), carbon black, and hydrotalcite.

The surface of the organic or inorganic fine powder may be hydrophobized to improve the flowability of the toner and to uniformly charge the toner particles. Examples of the treatment agent for hydrophobizing the organic or inorganic fine powder include unmodified silicone varnish, various modified silicone varnishes, unmodified silicone oil, various modified silicone oil, silane compounds, silane coupling agents, other organic silicon compounds, and organic titanium compounds. These treatment agents may be used alone or in combination.

Among them, it is preferable to include hydrotalcite as an external additive. By including hydrotalcite, which demonstrates charging performance of the opposite polarity to silica, which is the main component constituting the aggregates, the charging performance of the toner, specifically, the charge rising performance in a high-temperature and high-humidity environment, which is severe for the charge rising performance, is improved. Furthermore, it is more preferable that the hydrotalcite be fluorine-treated. This is because it is believed that by including fluorine, which has a high electronegativity, in the hydrotalcite, the transfer of charges is further promoted, thereby making it possible to obtain a higher effect.

Below, an example of a method for obtaining the above toner particles will be described, but this example is not limiting.

A method for producing the toner particles is not particularly limited, and suspension polymerization method, dissolution suspension method, emulsion aggregation method, pulverization method, etc. can be used. As an example, a method for obtaining the toner particles by emulsion aggregation is described hereinbelow.

### Production Method of Toner by Emulsion Aggregation

### Production Step of Polymer A

The production method of polymer A can be a conventionally known production method such as solution polymerization, suspension polymerization, emulsion polymerization, bulk polymerization, dispersion polymerization, etc., but is not limited to these. As an example, a method for obtaining polymer A by solution polymerization is described hereinbelow.

A monomer solution is prepared by dissolving a polymerizable monomer composition consisting of at least one (meth)acrylic acid esters having an alkyl group with 18 to 36 carbon atoms as a first polymerizable monomer, at least one second polymerizable monomers, and, if necessary, a third polymerizable monomer, in a solvent such as toluene. A polymerization initiator is added thereto, and the polymerizable monomers are polymerized to obtain a polymer solution in which polymer A is dissolved in a solvent such as toluene. The polymer solution is mixed with a solvent in which polymer A is insoluble (e.g., methanol etc.) to precipitate polymer A. The precipitated polymer A is filtered and washed to obtain polymer A.

### Resin Fine Particle-Dispersed Solution Preparation Step

The resin fine particle-dispersed solution can be prepared by known methods but is not limited to these. Examples include emulsion polymerization, self-emulsification, phase inversion emulsification, in which a resin is emulsified by adding an aqueous medium to a resin solution obtained by dissolving in an organic solvent, and forced emulsification, in which no organic solvent is used and a resin is forcibly emulsified by high-temperature treatment in an aqueous medium.

As an example, a method of preparing a resin fine particle-dispersed solution by the phase inversion emulsification method is described hereinbelow.

The resin components containing polymer A are dissolved in an organic solvent in which they dissolve, and a surfactant or a basic compound is added. At that time, if the resin component is a crystalline resin that has a melting point, the resin component can be dissolved by heating to at least the melting point. Next, while stirring with a homogenizer or the like, an aqueous medium is slowly added to precipitate the resin fine particles. After that, the solvent is removed by heating or reducing the pressure to prepare an aqueous dispersion liquid of resin fine particles.

Here, the organic solvent used to dissolve the resin components containing polymer A may be any organic solvent capable of dissolving these. Specific examples include toluene and xylene.

As the surfactant used in the preparation step, it is preferable to use a surfactant containing compound A or compound B. Surfactants can be used in combination within a range in which the effects of the present disclosure are not impaired. Examples of such surfactants include anionic surfactants such as sulfuric acid esters and salts, sulfonic acid salts, carboxylic acid salts, phosphoric acid esters, and soap-based surfactants; cationic surfactants such as amine salts and quaternary ammonium salts; and nonionic surfactants such as polyethylene glycols, alkylphenol ethylene oxide adducts, and polyhydric alcohols.

Examples of the basic compound that can be used in the preparation step include inorganic bases such as sodium hydroxide and potassium hydroxide; and organic bases such as ammonia, triethylamine, trimethylamine, dimethylaminoethanol, and di ethylaminoethanol. The basic compounds may be used alone or in combination of at least two types.

### Preparation of Colorant-Dispersed Solution

The colorant-dispersed solution can be prepared by a known dispersion method, and is not limited to any particular method. For example, a common dispersion means such as a homogenizer, a ball mill, a colloid mill, and an ultrasonic disperser can be used. Examples of the surfactants used during dispersion include those described above, and surfactants containing compound A or compound B are preferably used.

### Preparation of Wax-Dispersed Solution

When preparing a wax-dispersed solution, wax is dispersed in water together with a surfactant and a basic compound, and then the dispersion liquid is heated to a temperature of at least the melting point of the wax and dispersed using a homogenizer or disperser that applies a strong shear force. Through this process, a wax-dispersed solution is obtained. Examples of surfactants that can be used during dispersion include those described above, and surfactants containing compound A or compound B are preferably used. Examples of basic compounds that can be used during dispersion include those described above.

### Aggregated Particle Formation Step

In the aggregated particle formation step, first, a resin fine particle-dispersed solution, a colorant-dispersed solution, a wax-dispersed solution, etc. are mixed to obtain a mixed liquid. Next, the pH is made acidic to cause aggregation while heating at a temperature equal to or lower that the melting point of the resin fine particles, and aggregated particles containing resin fine particles, colorant particles, and release agent particles are formed, thereby obtaining an aggregated particle-dispersed solution.

### First Fusion Step

In the first fusion step, the pH of the aggregated particle-dispersed solution is increased under stirring conditions similar to those in the aggregated particle formation step to stop the progress of aggregation, and the fused particle-dispersed solution is obtained by heating at a temperature of at least the melting point of the polymer.

### Amorphous Resin Fine Particle Attachment Step

In the amorphous resin fine particle attachment step, an amorphous resin particle-dispersed solution is added to the fused particle-dispersed solution, and the pH is lowered to attach amorphous resin particles to the surface of the fused particles, thereby obtaining a dispersion liquid resin-attached particles. Here, this coating layer corresponds to a shell layer formed through a shell layer formation step described hereinbelow. The amorphous resin fine particle-dispersed solution can be produced in accordance with the described resin fine particle-dispersed solution preparation step.

### Second Fusion Step

In the second fusion step, the pH of the resin-attached particle-dispersed solution is increased to stop the progress of aggregation in accordance with the first fusion process, and the resin-attached aggregated particles are fused by heating at a temperature of at least the melting point of polymer A to obtain a toner core particle-dispersed solution in which toner core particles with a shell layer formed thereon are dispersed.

The strontium titanate fine particles can be produced, for example, by a normal-pressure heating reaction method. In this case, a mineral acid peptized product of a hydrolysate of a titanium compound may be used as the titanium oxide source, and a water-soluble acidic strontium source metal compound may be used as the strontium source.

In order to incorporate silicon into the strontium titanate fine particles, a method can be used in which protruding portions formed of silica fine particles are formed at the surface of the strontium titanate fine particles, or the surface is covered with silica fine particles.

In order to form the protruding portions formed of silica fine particles at the surface of strontium titanate fine particles, or to cover the surface with silica fine particles, a mineral acid peptized product of a hydrolysate of a titanium compound, a strontium source, and a silica-containing particle source are mixed together. The production can be carried out by a method in which an alkaline aqueous solution is added to the mixed liquid of the raw materials at 60° C. to 100° C. to cause a reaction, and then acid treatment is performed.

The normal-pressure heating reaction method will be described below.

As the titanium oxide source, a mineral acid peptized product of a hydrolysate of a titanium compound is used. Preferably, metatitanic acid with an SO₃ content of not more than 1.0% by mass, more preferably not more than 0.5% by mass, obtained by the sulfuric acid method, is used, treated with hydrochloric acid to adjust the pH to from 0.8 to 1.5 and peptized. Meanwhile, as the strontium source, a nitrate or hydrochloride of metal strontium can be used.

As the nitrate, for example, strontium nitrate can be used. As the hydrochloride, for example, strontium chloride can be used. The strontium titanate fine particles obtained here have a perovskite crystal structure, which is preferable in that the environmental stability of charging is further improved.

When the shape of the strontium titanate fine particles is controlled by mechanical treatment, fine powder of the strontium titanate fine particles may be generated. In order to remove the fine powder, it is preferable to perform an acid treatment after the mechanical treatment. In the acid treatment, it is preferable to adjust the pH to from 0.1 to 5.0 using hydrochloric acid. As the acid, in addition to hydrochloric acid, nitric acid, acetic acid, etc. can be used for the acid treatment.

In addition, as the silica-containing particle source, for example, sodium silicate, silica, etc. can be mentioned. By adding the silica-containing particle source, it is possible to produce strontium titanate fine particles containing silicon.

Examples of factors that affect the particle diameter of the obtained strontium titanate fine particle metal particles and the amount of silicon contained in the strontium titanate fine particles in this production method include the following.

The pH when metatitanic acid is peptized with hydrochloric acid, the mixing ratio of the titanium oxide source, strontium source, and silica-containing particle source, the concentration of the titanium oxide source at the beginning of the reaction, the concentration of the silica-containing particle source, the temperature when the alkaline aqueous solution is added, the addition rate, the reaction time, and the stirring conditions.

In addition, in the step of adding the alkaline aqueous solution, the half-width of the strontium titanate fine particles and the amount of silica contained therein can be controlled by adding the alkaline aqueous solution while applying ultrasonic vibrations. By applying ultrasonic vibrations in the reaction step, the rate of crystal precipitation can be increased and particles with a small crystallite size can be obtained. In order to control the half-width, it is preferable to add an alkaline aqueous solution and rapidly cool the aqueous solution after the reaction has been completed.

Asa method for rapid cooling, for example, pure water cooled to not higher than 10° C. can be added until the desired temperature is reached. Rapid cooling can prevent the crystallite size from becoming large in the cooling step.

Furthermore, if the reaction is stopped by rapidly lowering the temperature of the system, for example, by pouring the system into ice water after the addition of the alkaline aqueous solution, the reaction can be forcibly stopped in the course of crystal growth saturation, and the particle size distribution can be controlled.

Furthermore, the particle size distribution can be controlled by making the state of the reaction system non-uniform by reducing the stirring speed or changing the stirring method.

These factors can be adjusted, as appropriate, to obtain metal titanate fine particles and silicon-containing strontium titanate fine particles with the desired particle diameter and particle size distribution. In addition, it is preferable to prevent the inclusion of carbon dioxide gas, for example, by carrying out the reaction under a nitrogen gas atmosphere to prevent the formation of carbonates during the reaction process.

The mixing ratio of the titanium oxide source and the strontium source during the reaction is preferably 0.90 to 1.40 in molar ratio SrO/TiO₂, and more preferably 1.05 to 1.20, where Sr represents strontium and SrO represents an oxide thereof.

When the SrO/TiO₂ (molar ratio) is not more than 1.00, the reaction product is likely to contain not only metal titanate but also unreacted titanium oxide. Since strontium has a relatively high solubility in water while the titanium oxide source has a low solubility in water, when the SrO/TiO₂ (molar ratio) is not more than 1.00, the reaction product tends to contain not only metal titanate but also unreacted titanium oxide.

The concentration of the titanium oxide source at the beginning of the reaction is preferably from 0.050 mol/L to 1.300 mol/L, and more preferably from 0.080 mol/L to 1.200 mol/L, in terms of TiO₂.

By increasing the concentration of the titanium oxide source at the beginning of the reaction, the number-average particle diameter of the primary particles of the strontium titanate fine particles can be reduced.

When adding the alkaline aqueous solution, since a pressure vessel such as an autoclave is needed if the temperature is at least 100° C., a temperature of from 60° C. to 100° C. is preferable from the practical standpoint.

In addition, the slower the addition rate, the larger the particle size of the strontium titanate fine particles and the larger the protrusions formed of silica. Meanwhile, the faster the addition rate, the smaller the particle size of the strontium titanate fine particles and the smaller the protrusions formed of silica.

The rate of addition of the alkaline aqueous solution is preferably from 0.001 equivalent/h to 1.2 equivalent/h, more preferably from 0.002 equivalent/h to 1.1 equivalent/h, relative to the loaded raw material. These can be adjusted, as appropriate, according to the particle diameter to be obtained.

In this production method, it is preferable that the strontium titanate fine particles obtained by the normal-pressure heating reaction be further treated with an acid. When performing the normal-pressure heating reaction to produce strontium titanate fine particles, if the mixing ratio of the titanium oxide source and the strontium source exceeds 1.00 in terms of SrO/TiO₂ (molar ratio), the unreacted strontium remaining after completion of the reaction may react with carbon dioxide gas in the air, which may easily generate impurities such as metal carbonates. In addition, where impurities such as metal carbonates remain on the surface, it becomes difficult, due to the influence of the impurities, to uniformly coat the surface treatment agent when performing surface treatment to impart hydrophobicity. Therefore, after adding the alkaline aqueous solution, an acid treatment may be performed to remove the unreacted metal source.

In the acid treatment, it is preferable to adjust the pH to from 2.5 to 7.0 using hydrochloric acid, and more preferably to adjust the pH to from 4.5 to 6.0.

As the acid, in addition to hydrochloric acid, nitric acid, acetic acid, etc. can be used for the acid treatment. When sulfuric acid is used, metal sulfates with low solubility in water are likely to be generated.

The surface of the strontium titanate fine particles disclosed herein can be treated and the shape thereof may be controlled. The strontium titanate fine particles preferably have a cubic or rectangular parallelepiped shape. In addition, a method of performing a dry mechanical treatment may be used as a method of controlling the shape of the strontium titanate fine particles.

The strontium titanate fine particles may be subjected to surface treatment. The surface treatment agent is not particularly limited, but examples thereof include disilylamine compounds, halogenated silane compounds, silicone compounds, and silane coupling agents. The ratio value (Si/Sr) can be controlled by the surface treatment agent.

The disilylamine compound is a compound having a disilylamine (Si—N—Si) moiety. Examples of disilylamine compounds include hexamethyldisilazane (HMDS), N-methyl-hexamethyldisilazane, and hexamethyl-N-propyldisilazane. An example of a halogenated silane compound is dimethyldichlorosilane.

Examples of silicone compounds include silicone oils and silicone resins (varnishes). Examples of silicone oils include dimethylsilicone oil, methylphenylsilicone oil, α-methylstyrene-modified silicone oil, chlorophenyl silicone oil, and fluorine-modified silicone oil. Examples of silicone resins (varnishes) include methylsilicone varnish and phenylmethyl silicone varnish.

Examples of silane coupling agents include silane coupling agents having an alkyl group and an alkoxy group, silane coupling agents having an amino group and an alkoxy group, and fluorine-containing silane coupling agents.

Specific examples of silane coupling agents include dimethyldimethoxysilane, dimethyldiethoxysilane, di ethyldimethoxysilane, di ethyldiethoxysilane, trimethylmethoxysilane, trimethyldiethoxysilane, triethylmethoxysilane, triethyldiethoxysilane, propyltrimethoxysilane, propyltriethoxysilane, isobutyltrimethoxysilane, octyltrimethoxysilane, octyltriethoxysilane, γ-glycidoxypropyltrimethoxysilane, γ-chloropropyltrimethoxysilane, γ-aminopropyltrimethoxysilane, γ-aminopropyltriethoxysilane, γ-aminopropyldimethoxymethylsilane, γ-aminopropyldiethoxymethylsilane, 3,3,3-trifluoropropyldimethoxysilane, 3,3,3-trifluoropropyldiethoxysilane, perfluorooctylethyltriethoxysilane, and 1,1.1-trifluorohexyldiethoxysilane.

The silane coupling agent is preferably a silane coupling agent having an alkyl group and an alkoxy group, such as dimethyldimethoxysilane, dimethyldiethoxysilane, di ethyldimethoxysilane, di ethyldiethoxysilane, trimethylmethoxysilane, trimethyldiethoxysilane, triethylmethoxysilane, triethyldiethoxysilane, propyltrimethoxysilane, propyltriethoxysilane, isobutyltrimethoxysilane, octyltrimethoxysilane, or octyltriethoxysilane.

Among the above silane coupling agents, those having an alkyl group with not more than four carbon atoms are preferred from the viewpoint of charging performance, and it is more preferred that the silane coupling agent be treated with isobutyltrimethoxysilane.

The preferred amount of the treatment agent is 0.5 parts by mass to 25.0 parts by mass per 100 parts by mass of the strontium titanate fine particles.

The above surface treatment agents may be used alone or in combination of at least two.

The C amount (carbon amount) of the strontium titanate fine particles that is derived from the hydrophobic treatment agent is, for example, 0.5% by mass to 10.0% by mass, and preferably 0.8% by mass to 5.0% by mass. When the C amount is within the above ranges, the charge rising performance and charge stability are improved.

The titanium oxide fine particles can be preferably produced by a known production method.

The titanium oxide fine particles may be subjected to a surface treatment with a surface treatment agent.

As the surface treatment agent, for example, a hydrophobic treatment agent can be used. Examples of hydrophobic treatment agents include chlorosilanes such as methyltrichlorosilane, dimethyldichlorosilane, trimethylchlorosilane, phenyltrichlorosilane, diphenyldichlorosilane, t-butyldimethylchlorosilane, and vinyltrichlorosilane; alkoxysilanes such as silantetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl)aminopropylmethyldimethoxysilane; silazanes such as hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane; silicone oils such as dimethyl silicone oil, methylhydrogensilicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminally reactive silicone oil; and siloxanes such as hexamethylcyclotrisiloxane, octamethylcyclotetrasiloxane, decamethylcyclopentasiloxane, hexamethyldisiloxane, and octamethyltrisiloxane.

Next, a method for externally adding titanium oxide fine particles and strontium titanate fine particles to toner particles will be described.

In the step of adding titanium oxide fine particles and strontium titanate fine particles to toner particles, the fine particles may be added as an external additive by a dry method, may be added by a wet method, or may be added in two stages by respective methods. In particular, from the viewpoint of controllability of the state of presence of titanium oxide fine particles and strontium titanate fine particles, it is more preferable to adopt a two-stage external addition process. In order to control A/(A+B) within an appropriate range, it is necessary to embed the titanium oxide fine particles in the toner particles surface, so it is more preferable to take into consideration the step of externally adding the titanium oxide fine particles as the first step.

To embed the titanium oxide fine particles in the toner particle surface, a method of heating the external addition device in the external addition step (a step of mixing the toner particles with the titanium oxide fine particles) and embedding the titanium oxide fine particles by heat can be preferably used. The titanium oxide fine particles can be embedded by applying a mechanical impact force to the toner particle surface that has been slightly softened by heat. Alternatively, a method may be used in which the toner particles and the titanium oxide fine particles are mixed in the external addition step, and then a heating step is provided in the same device or a different device to embed the titanium oxide fine particles.

To achieve the embedding of the titanium oxide fine particles, it is preferable to set the temperature in the external addition step near the glass transition temperature Tg of the toner particle. From the viewpoint of storage stability, the glass transition temperature Tg of the toner particle is preferably from 40° C. to 70° C., more preferably from 50° C. to 65° C. The device used in the step of adding titanium oxide fine particles preferably has a mixing function and a function of applying a mechanical impact force, and a known mixing processing device can be used. For example, titanium oxide fine particles can be embedded in toner particles by using a known mixing machine such as an FM Mixer (manufactured by Nippon Coke & Engineering Co., Ltd.), a Super Mixer (manufactured by Kawata Co., Ltd.), or a Hybridizer (manufactured by Nara Machinery Co., Ltd.) that has been heated in advance.

The dispersion evaluation index of titanium oxide fine particles can be adjusted by changing the conditions for adding titanium oxide fine particles to the toner particles. For example, the change in the external addition field, such as dry or wet, the rotation speed of the external addition blade, and the external addition time can be mentioned.

Next, a method for externally adding strontium titanate fine particles to toner particles will be explained. From the viewpoint of flowability, it is preferable to set production conditions under which strontium titanate fine particles are difficult to embed. Examples of production conditions under which strontium titanate fine particles are difficult to embed include a method of weakening the mechanical impact force. The same device as that used in the step of externally adding titanium oxide fine particles can be used as the external addition device.

### Measurement Methods

The methods for measuring various physical properties will be described hereinbelow.

### Method for Measuring Weight-Average Particle Diameter (D4) and Number-Average Particle Diameter (D1)

The weight-average particle diameter (D4) and number-average particle diameter (D1) of the toner are calculated as follows. The measuring device is a precision particle side distribution measuring device using the pore electrical resistance method, “Coulter Counter Multisizer 3” (registered trademark, manufactured by Beckman Coulter, Inc.), equipped with a 100 μm aperture tube. The measurement conditions are set and the measurement data are analyzed using the dedicated software “Beckman Coulter Multisizer 3 Version 3.51” (manufactured by Beckman Coulter, Inc.) provided with the device. The measurement is performed with an effective measurement channel count of 25,000.

The electrolyte solution used for the measurement is one in which special grade sodium chloride is dissolved in ion-exchanged water to a concentration of 1% by mass, for example, “ISOTON II” (manufactured by Beckman Coulter, Inc.) can be used.

Before carrying out measurements and analysis, the dedicated software is set up as follows.

On the “Change Standard Measurement Method (SOMME)” screen of the dedicated software, the total count in control mode is set to 50,000 particles, the number of measurements is set to 1, and the Kd value is set to the value obtained using “Standard Particle 10.0 μm” (manufactured by Beckman Coulter, Inc.). The threshold and noise level are automatically set by pressing the “Threshold/Noise Level Measurement Button.” In addition, the current is set to 1600 μA, the gain to 2, the electrolyte to ISOTON II, and “Flush Aperture Tube After Measurement” is checked.

On the “Pulse to Particle Diameter Conversion Setting” screen of the dedicated software, the bin interval is set to logarithmic particle diameter, the particle diameter bin to 256 particle diameter bins, and the particle diameter range to 2 μm to 60 μm.

The specific measurement method is as follows:
(1) Approximately 200 mL of the electrolyte solution is placed in a 250 mL round-bottom glass beaker made specifically for the Multisizer 3, the beaker is set on the sample stand, and stirring is performed with a stirrer rod counterclockwise at 24 rev/s. Then, the “Aperture Flush” function of the dedicated software is used to remove dirt and air bubbles from inside the aperture tube.
(2) A total of 30 mL of the electrolyte solution is placed in a 100 mL flat-bottom glass beaker. Then, 0.3 mL of a diluted solution prepared by an approximately three-fold mass dilution of “Contaminon N” (a 10% by mass aqueous solution of a neutral detergent for cleaning precision measuring instruments that has a pH of 7 and contains a nonionic surfactant, an anionic surfactant, and an organic builder; manufactured by Wako Pure Chemical Industries, Ltd.) with ion-exchanged water is added as a dispersant.
(3) An ultrasonic dispersion device “Ultrasonic Dispersion System Tetra 150” (manufactured by Nikkaki Bios Co., Ltd.) is prepared, which has two built-in oscillators with an oscillation frequency of 50 kHz, with the phase being shifted by 180°, and an electrical output of 120 W. A total of 3.3 L of ion-exchanged water is placed in the water tank of the ultrasonic dispersion device, and 2 mL of Contaminon N is added to the water tank.
(4) The beaker from (2) is set in the beaker fixing hole of the ultrasonic dispersion device, and the ultrasonic dispersion device is operated. Then, the height position of the beaker is adjusted so that the resonance state of the liquid surface of the electrolyte solution in the beaker is maximized.
(5) While the electrolyte solution in the beaker from (4) is irradiated with ultrasonic waves, 10 mg of toner is added to the electrolyte solution in small amounts at a time and dispersed. Then, the ultrasonic dispersion process is continued for another 60 sec. During ultrasonic dispersion, the water temperature in the water tank is adjusted, as appropriate, to from 10° C. to 40° C.
(6) Using a pipette, the electrolyte aqueous solution of (5) in which the toner has been dispersed is dropped into the round-bottomed beaker of (1) placed in the sample stand, and the measurement concentration is adjusted to 5%. Then, measurements are performed until the number of particles measured reaches 50,000.
(7) The measurement data are analyzed using the dedicated software provided with the device, and the weight-average particle diameter (D4) and number-average particle diameter (D1) are calculated. When the dedicated software is set to Graph/Volume %, the “Average diameter” on the “Analysis/Volume Statistics (Arithmetic Mean)” screen is the weight-average particle diameter (D4), and when the dedicated software is set to Graph/Number %, the “Average diameter” on the “Analysis/Number Statistics (Arithmetic Mean)” screen is the number-average particle diameter (D1).

### Method for Isolating Strontium Titanate Fine Particles and Titanium Oxide Fine Particles

When measuring the physical properties of strontium titanate fine particles, titanium oxide fine particles, and other external additives, as well as toner particles, by using a toner to which the strontium titanate fine particles and the like have been added, the strontium titanate fine particles and titanium oxide fine particles can be separated from the toner and measured.

The toner is ultrasonically dispersed in methanol to remove the strontium titanate fine particles and titanium oxide fine particles, and then allowed to stand for 24 h. The toner particles can be isolated by separating and collecting the settled toner particles and the strontium titanate fine particles and titanium oxide fine particles dispersed in the supernatant liquid, and thoroughly drying the collected particles. In addition, the strontium titanate fine particles and titanium oxide fine particles can be isolated by treating the supernatant liquid by centrifugation.

### Method for Measuring the Content of Strontium Titanate Fine Particles and Titanium Oxide Fine Particles

The strontium titanate fine particles and titanium oxide fine particles are isolated from the toner by the method described above. The masses of the obtained toner particles, strontium titanate fine particles, and titanium oxide fine particles are measured. From the masses of the obtained toner particles, strontium titanate fine particles, and titanium oxide fine particles, the respective contents per 100 parts by mass of the toner particles can be calculated.

### Method for Measuring Number-Average Particle Diameter of Primary Particles of Strontium Titanate Fine Particles and Primary Particles of Titanium Oxide Fine Particles

The number-average particle diameter of primary particles of strontium titanate fine particles is measured using a transmission electron microscope (TEM) “JEM2800” (manufactured by JEOL Ltd.). The strontium titanate fine particles separated by the above-mentioned procedure can be used.

First, the measurement sample is prepared. A total of 1 mL of isopropanol is added to 5 mg of each external additive to be measured, and the components are dispersed for 5 min using an ultrasonic disperser (ultrasonic cleaner). Next, a drop of the above dispersion liquid is placed on a microgrid (150 mesh) with a support film for TEM, and the measurement sample is prepared by drying.

Next, a transmission electron microscope (TEM) is used to obtain images at an accelerating voltage of 200 kV and a magnification (e.g., 200 k to 1M) that enables sufficient measurement of the length of the external additive in the field of view, the major axis of 100 primary particles of the external additive is measured randomly so as not to be arbitrary, and the number-average particle diameter is calculated. The particle diameter of the primary particles is measured using image processing software “Image-Pro Plus ver. 4.0 (manufactured by Media Cybernetics, Inc.)”.

The number-average particle diameter of the primary particles of titanium oxide fine particles can also be measured using a similar method.

### Si/Sr of Strontium Titanate Fine Particles

The silicon and strontium content (mass) of the strontium titanate fine particles used in this disclosure can be measured using an X-ray fluorescence analyzer. Using a wavelength-dispersive X-ray fluorescence analyzer Axios advanced (manufactured by PANalytical), 1 g of sample is weighed into a cup recommended by PANalytical for powder measurement with a special film attached, and elements from Na to U in the strontium titanate fine particles are measured by the FP method in a He atmosphere under atmospheric pressure. The strontium titanate fine particles separated by the above-mentioned procedure can be used as the sample.

In this case, it is assumed that all detected elements are oxides, the total mass thereof is set to 100%, and the content (% by mass) of silicon oxide and strontium oxide relative to the total mass is calculated as an oxide equivalent value using the software SpectraEvaluation (version 5.0 L). After that, the Si/Sr (mass ratio) is determined by excluding oxygen from the quantitative results.

### Method for Measuring Water Washing Adhesion Rate α of Strontium Titanate Fine Particles and Water Washing Adhesion Rate β of Titanium Oxide Fine Particles

A total of 160 g of sucrose (Kishida Chemical) is added to 100 mL of ion-exchanged water and dissolved in a hot water bath to prepare a concentrated sucrose solution. Then, 31 g of the concentrated sucrose solution and 6 mL of Contaminon N (a 10% by mass aqueous solution of a neutral detergent for cleaning precision measuring instruments that has a pH of 7 and contains a nonionic surfactant, an anionic surfactant, and an organic builder; manufactured by Wako Pure Chemical Industries, Ltd.) are added to a centrifuge tube (volume 50 ml) to prepare a dispersion liquid. A total of 1.0 g of toner is added to this dispersion liquid and the toner lumps are broken up with a spatula or the like. The centrifuge tube is shaken with a shaker (“KM Shaker”, manufactured by Iwaki Sangyo Co., Ltd.) at 350 spm (strokes per minute) for 20 min. After shaking, the solution is transferred to a glass tube for a swing rotor (volume 50 mL) and separated in a centrifuge (H-9R, manufactured by Kokusan Co., Ltd.) under the conditions of 3500 rpm and 30 min. Sufficient separation of the toner and aqueous solution is visually checked, and the toner that has separated to the top layer is collected with a spatula or the like. The aqueous solution containing the collected toner is filtered with a vacuum filter, followed by drying in a dryer for at least 1 h. The dried product is crushed with a spatula, and the amount of strontium element contained in the strontium titanate fine particles is measured using fluorescent X-rays. The water washing adhesion rate α (%) of the strontium titanate fine particles is calculated from the strontium element amount ratio between the toner treated with the above dispersion liquid and the initial toner.

The water-washing adhesion rate α (%) of strontium titanate fine particles is determined by (amount of strontium element in toner particle after water-washing process/amount of strontium element in initial toner particle)×100.

Next, the titanium element amount ratio is confirmed using the same method, and the water-washing adhesion rate of titanium is calculated. Of the water-washing adhesion rate of titanium, α (%) can be considered to represent titanium derived from strontium titanate fine particles, so the product of the water-washing adhesion rate (%) of titanium and (100−α) can be calculated as the water-washing adhesion rate β (%) of titanium oxide fine particles.

The measurement of fluorescent X-rays of each element conforms to JIS K 0119 1969, but is specifically as follows. The measurement device used is a wavelength dispersive X-ray fluorescence analyzer “Axios” (manufactured by PANalytical) that is provided with the dedicated software “SuperQ ver. 4.0F” (manufactured by PANalytical) for setting the measurement conditions and analyzing the measurement data. Rh is used as the anode of the X-ray tube, the measurement atmosphere is vacuum, the measurement diameter (collimator mask diameter) is 10 mm, and the measurement time is 10 sec. In addition, when measuring light elements, they are detected by a proportional counter (PC), and when measuring heavy elements, they are detected by a scintillation counter (SC). As the measurement sample, a pellet is used that is obtained by placing about 1 g of the toner treated with the above dispersion liquid or the initial toner in a dedicated aluminum ring for pressing with a diameter of 10 mm, flattening, pressing at 20 MPa for 60 sec using a tablet molding compression machine “BRE-32” (manufactured by Maekawa Test Machinery Manufacturing Co., Ltd.) and molding to a thickness of about 2 mm. Measurements are performed under the above conditions, the elements are identified based on the peak positions of the obtained X-rays, and the concentrations thereof are calculated from the counting rate (unit: cps), which is the number of X-ray photons per unit time.

The strontium titanate fine particles are added to obtain 0.5 parts by mass thereof with respect to 100 parts by mass of toner particles, and mixed thoroughly using a coffee mill to prepare a calibration curve sample containing 0.5 parts by mass of strontium titanate fine particles. In the same manner, a calibration curve sample in which the number of parts of strontium titanate fine particles added is 1.0 part by mass, and a calibration curve sample in which the number of parts of strontium titanate fine particles added is 2.0 parts by mass are prepared.

For each sample, pellets of the calibration curve sample are prepared as described above using a tablet molding compression machine, and the Kα ray net intensity of the strontium element and titanium element of the strontium titanate fine particles is measured. A linear function calibration curve is obtained by plotting the obtained X-ray count rate on the vertical axis and the amount of strontium titanate fine particles added in each calibration curve sample on the horizontal axis. The contents of strontium titanate fine particles and titanium oxide fine particles in the actual toner are calculated using the linear function calibration curve described above.

For the actual toner, the Kα ray net intensity of strontium element and titanium element is measured using the toner pellets to be analyzed. The contents of strontium titanate fine particles and titanium oxide fine particles in the toner are then obtained from the calibration curve described above. In the same manner as in the method for calculating the water washing method adhesion rate β described above, the content of titanium oxide fine particles can be calculated by subtracting the Kα ray net intensity of titanium element calculated from the content of strontium titanate fine particles calculated from the strontium element from the actual measurement value.

The ratio of the element amount of the toner treated with the above dispersion liquid to the element amount of the initial toner calculated by the above method is obtained to calculate the water washing method adhesion rate.

### Method for Measuring Dispersion Evaluation Index of Titanium Oxide Fine Particles

The dispersion evaluation index of titanium oxide fine particles at the toner surface is calculated using the backscattered electron image obtained with a scanning electron microscope (SEM) and the element mapping image obtained by energy dispersive X-ray analysis (EDS).

The backscattered electron image obtained with the SEM is also called a “composition image”, and the smaller the atomic number, the darker is the detected image, and the larger the atomic number, the brighter is the detected image.

Toner particles are generally resin particles that mainly contain carbon-based compositions such as resin components and release agents. When silicon-containing strontium titanate fine particles or metal oxides are present at the surface of the toner particles, the strontium titanate fine particles and titanium oxide fine particles are observed as bright areas, and the resin portions mainly composed of carbon are observed as dark areas in the backscattered electron image obtained from the SEM. When focusing on strontium titanate fine particles and titanium oxide fine particles, it is possible to distinguish between the two because strontium titanate fine particles contain strontium element, which is a heavier element.

The SEM device and observation conditions are as follows.
Device used: ULTRA PLUS, manufactured by Carl Zeiss Microscopy Co., Ltd.
Accelerating voltage: 1.0 kV
WD: 2.0 mm
Aperture Size: 30.0 μm
Detection signal: EsB (energy-selective backscattered electrons)
EsB Grid: 800 V
Observation magnification: 10,000 times
Contrast: 63.0±5.0% (reference value)
Brightness: 38.0±5.0% (reference value)
Resolution: 1024×768 pixels
Pretreatment: toner particles are scattered on carbon tape (no vapor deposition is performed)

The contrast and brightness are set, as appropriate, according to the state of the device used. The accelerating voltage and EsB Grid are set to achieve the following: acquisition of structural information on the outermost surface of the toner particles, prevention of charging up of undeposited samples, and selective detection of high-energy reflected electrons.

The observed image is binarized using the image processing software “Image-Pro Plus 5.1J” (manufactured by Media Cybernetics, Inc.) so that only titanium oxide fine particles are extracted. The number n of titanium oxide fine particles is calculated, the coordinates of the center of gravity of all titanium oxide fine particles are calculated, and the distance dnₘᵢₙ between each titanium oxide fine particle and the nearest titanium oxide fine particle is calculated. The average value of the nearest distance between titanium oxide fine particles in the image is taken as dₐᵥₑ, and the dispersion evaluation index for one toner is calculated using the formula below.

$$( Dispersion evaluation index ) = \sqrt{\frac{{\sum }_{1}^{n} {( d {n}_{min} - {d}_{a v e} )}^{2}}{n}} / {d}_{a v e}$$

The dispersion is obtained using the above procedure for 50 toner particles observed randomly so as not to be arbitrary, and the arithmetic average value of the results is taken as the dispersion evaluation index.

Calculation Method for Total Area A of Titanium Oxide Fine Particles Present on Contour of Cross Section of Toner Particle and within 30 nm Inside the Contour of the Cross Section of the Toner Particle, Total Area B of Titanium Oxide Fine Particles Present Outside the Contour of the Cross Section of the Toner Particle, and Standard Deviation C of A/(A+B)

The area of titanium oxide fine particles present on the contour of a cross section of a toner particle and within 30 nm inside the contour of the toner particle is calculated using a scanning transmission electron microscope (STEM).

A cross section of toner observed with STEM is prepared as follows.

The procedure for preparing a cross section of toner is explained below.

First, in order to prepare a cross section of toner, a mixed powder is prepared by mixing an embedding resin and a toner. A resin containing a metal element not contained in the toner is selected as the resin for embedding the toner. The resin containing a metal element not contained in the toner is not particularly limited as long as it has an appropriate deformability at room temperature, but for example, a metal salt of a long-chain fatty acid can be suitably used. Among the long-chain fatty acid metal salts, zinc stearate and magnesium stearate, which have a relatively low melting point, are more preferably used.

A total of 100 parts by mass of embedding resin is weighed out for 1 part by mass of toner and placed in a sample bottle. The sample bottle is then shaken at 500 rpm for 30 min to prepare a mixed powder of the toner and embedding resin.

The mixed powder is then pressurized at 20 MPa for 10 min to prepare a pellet-shaped pressurized molded piece (hereinafter referred to as a pellet).

The pellet is cut with an ultrasonic ultramicrotome (Leica, UC7) at a cutting speed of 0.6 mm/s to expose the cross section of the toner.

Next, the toner is cut to a film thickness of 500 nm to prepare a thin sample of the toner cross section. By cutting in this manner, a cross section of the toner can be obtained.

The cross section of the toner is observed using JEM-2800 (manufactured by JEOL Ltd.) at an acceleration voltage of 100 kV. A clear image is acquired with an STEM probe size of 1 nm and an image size of 512×512 pixels. The image is magnified at 100,000 times, and the image is acquired so that at least one-fourth or more of the circumference of the cross section of one toner particle is included.

The cross section of the toner to be imaged is selected to have a major axis that is 0.9 to 1.1 times the number-average particle diameter (D1) of the toner.

In parallel with the acquisition of the shape image, a mapping analysis of the elements contained in the observed image is performed using an energy dispersive X-ray spectrometer (EDS). The elements to be measured are selected to be those contained in the toner and the embedding resin in the correct amount. The mapping resolution is 256×256 pixels, and the analysis is performed at 0.01 μm/pixel.

The images obtained in the above elemental analysis are analyzed using the image processing software ImageJ to calculate the total area of titanium oxide fine particles that are present on the contour of the cross section of the toner particle and within 30 nm inside the contour of the cross section of the toner particle.

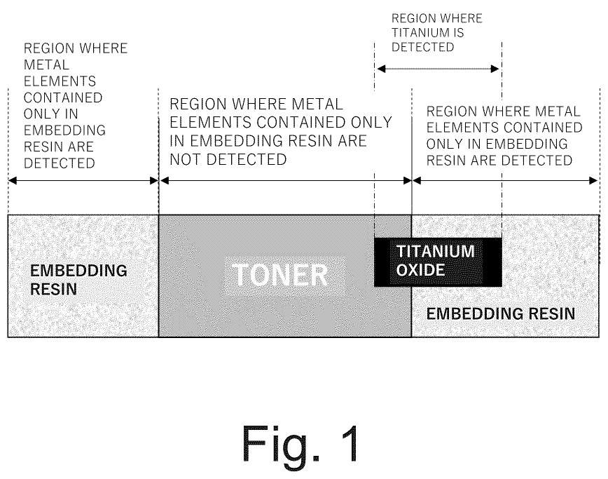

Since the cutting film thickness of 500 nm is sufficiently small compared to normal toner, it can be determined that the region where metal elements contained only in the embedding resin (for example, zinc element when zinc stearate is used) are detected is outside the toner. In contrast, external additives are usually smaller than the cutting film thickness of 500 nm, so that the region where the external additives are present inside the toner and the region where the external additives are present outside the toner and are enclosed in the embedding resin are detected as shown in FIG. 1.

In other words, in the region where the external additives are present outside the contour of the cross section of the toner particle, both the metal elements contained only in the embedding resin and the elements of the external additives are detected. Meanwhile, in the case of external additives present on the contour of the cross section of the toner particle and inside the contour of the cross section of the toner particle, the elements of the external additives are detected, but the metal elements contained only in the embedding resin are not detected.

Using the above method, the total area A (pixels) of the titanium oxide fine particles present on the contour of the cross section of the toner particle and within 30 nm inside the contour of the cross section of the toner particle can be defined as follows.
A (pixels)=“The number of pixels present in a region within 30 nm from the contour of the cross section of a toner particle toward the center of gravity (geometric center) of the toner particle where elements derived from the titanium oxide fine particles are detected and metal elements contained only in the embedding resin are not detected”

Measurement of whether an element is present within 30 nm inside the contour of the cross section of the toner particle can be performed using ImageJ in the following procedure. First, an element mapping image of the metal elements contained only in the embedding resin is open in ImageJ. Next, the scale length of 1 pixel on the image is set. Where a scale bar is displayed on the image, it can be overlaid with Straight Line on the Straight tab, and the length of the scale on the image can be set with Set Scale on the Analyze tab.

Next, 8 bit is selected in Type on the Image tab, the image is converted to a monochrome image, and a smoothing processing is performed using Smooth on the Process tab. Next, Adjust Threshold is opened on the Image tab and the image is binarized to obtain a binarized image. Default is selected as the binarization condition. This procedure makes it possible to distinguish between regions where metal elements contained only in the embedding resin are detected and regions where they are not contained. By overlaying the obtained binarized image with the STEM shape image and drawing a line segment equivalent to 30 nm from the contour of the cross section of the toner particle toward the center of gravity (geometric center) using the Straight Line in the Straight tab, it is possible to measure whether the area is within 30 nm inside the contour of the cross section of the toner particle.

The total area B (pixels) of the titanium oxide fine particles present outside the contour of the cross section of the toner particle can be defined as follows.
B (pixels)=“The number of pixels where both titanium element and metal elements contained only in the embedding resin are detected”

Using the above procedure, the total area A (pixels) of the titanium oxide fine particles present on the contour of the cross section of the toner particle and within 30 nm inside the contour of the cross section of the toner particle, and the total area B (pixels) of the titanium oxide fine particles present outside the contour of the cross section of the toner particle are calculated, and the value of A/(A+B) is calculated. The above procedure is performed for 50 fields of view, and the arithmetic mean value of the A/(A+B) values obtained for each field of view is adopted as the A/(A+B) value for that toner. The standard deviation of the A/(A+B) values for the 50 fields of view is taken as the standard deviation C.

### Measurement of Powder Resistivity of Strontium Titanate Fine Particles and Titanium Oxide Fine Particles

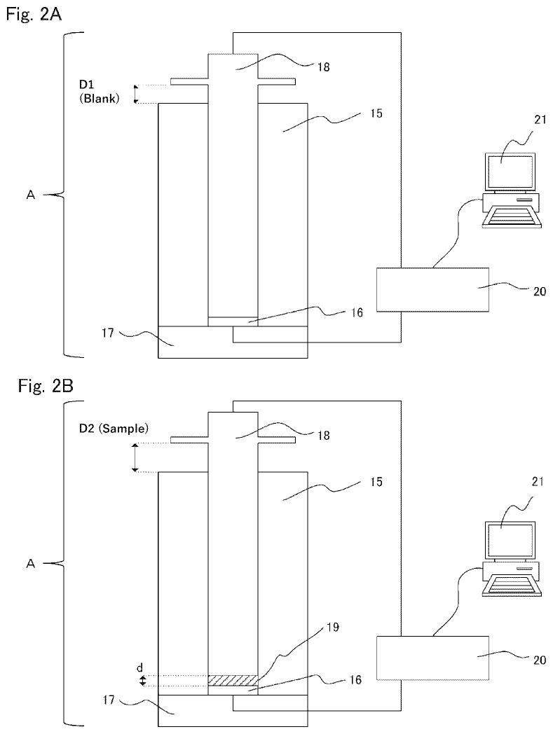

The resistance of the strontium titanate fine particles is measured using a measuring device shown in FIGS. 2A and 2B. When measuring a sample, the sample is allowed to stand in an environment of 23° C. and 50% RH for 24 h before measurement. The resistance measurement cell A is composed of a cylindrical PTFE resin container 15 with a hole having a cross-sectional area of 2.4 cm², a lower electrode (made of stainless steel) 16, a support base (made of PTFE resin) 17, and an upper electrode (made of stainless steel) 18. The cylindrical PTFE resin container 15 is placed on the support base 17, 0.7 g of the sample 19 is filled, and the upper electrode 18 is placed on the filled sample 19 to measure the thickness of the sample. Where the thickness without a sample is denoted by D1 (blank) (FIG. 2A), the actual thickness of the sample when 0.7 g is filled is denoted by d, and the thickness when the sample is filled is denoted by D2 (sample) (FIG. 2B), the thickness d of the sample is expressed by the formula below:

d=D2(sample)−D1(blank)

Then, the resistivity can be obtained by applying a voltage between the electrodes and measuring the current that flows at that time. For the measurement, an electrometer 20 (Keithley 6517, manufactured by Keithley Instruments Co., Ltd.) and a computer 21 for control are used. The measurement conditions are a contact area S of 2.4 cm² between the sample and the electrode, and a load of 230 g on the upper electrode. The voltage application conditions are as follows: an IEEE-488 interface is used to control between the control computer and the electrometer, and the auto-range function of the electrometer is used to apply voltages of 1 V, 2 V, 4 V, 8 V, 16 V, 32 V, 64 V, 128 V, 256 V, 512 V, and 1000 V for 1 sec each for screening.

At this time, the electrometer determines whether a maximum of 1000 V (for example, for a sample thickness of 1.00 mm, the electric field strength is 10,000 V/cm) can be applied, and if an overcurrent flows, “VOLTAGE SOURCE OPERATE” flashes. The applied voltage is then lowered, and further screening of the applicable voltage is performed, and the maximum applied voltage is automatically determined. After that, the actual measurement is performed.

The resistance is measured from the current value after a voltage obtained by dividing a maximum voltage value into five steps has been held for 30 sec for each step. For example, when the maximum applied voltage is 1000 V, the voltage is applied by increasing and then decreasing in increments of 200 V, which is ⅕ of the maximum applied voltage, in the order of 200 V (first step), 400 V (second step), 600 V (third step), 800 V (fourth step), 1000 V (fifth step), 1000 V (sixth step), 800 V (seventh step), 600 V (eighth step), 400 V (ninth step), and 200 V (tenth step), and the resistance value is measured from the current value after holding for 30 sec at each step. The electric field strength and resistivity are calculated by processing the data using a computer and plotted on a graph. The resistivity at an electric field strength of 1000 V/cm is read from the plot. The resistivity and electric field strength are calculated using the formula below.

$$Resistivity ( μΩ \cdot cm ) = ( applied voltage ( V ) / measured current ( A ) ) \times S ( {cm}^{2} ) / d ( cm ) \times 1 {0}^{6}$$

$$Field strength ( V / cm ) = applied voltage ( V ) / d ( cm )$$

The powder resistivity value of titanium oxide fine particles can also be measured using a similar method.

### EXAMPLES

The present disclosure will be specifically explained using the production examples and examples shown below. However, these do not limit the present disclosure in any way. In the production examples and examples, “parts” and “%” are all based on mass unless otherwise specified.

Production examples of toner particles will be explained hereinbelow.

### Preparation of Resin Particle-Dispersed Solution 1

A total of 78.0 parts of styrene, 20.7 parts of butyl acrylate, 1.3 parts of acrylic acid as a carboxyl group-providing monomer, and 3.2 parts of n-lauryl mercaptan were mixed and dissolved. This solution was added with the entire amount of an aqueous solution prepared by dissolving 2.0 parts of sodium linear alkylbenzene sulfonate (manufactured by Fujifilm Wako Pure Chemical Industries, Ltd.) in 150 parts of ion-exchanged water to disperse the resin particles.

An aqueous solution of 0.3 parts of potassium persulfate and 10 parts of ion-exchanged water was added with slow stirring for a further 10 min. After nitrogen replacement, emulsion polymerization was carried out at 70° C. for 6 h. After polymerization was completed, the reaction solution was cooled to room temperature and ion-exchanged water was added, thereby obtaining resin particle-dispersed solution 1 with a concentration of solids of 12.5% by mass and a volume-based median diameter of 0.2 μm.

### Preparation of Release Agent-Dispersed Solution 1

A total of 100 parts of release agent (behenyl behenate, melting point: 72.1° C.), 15 parts of sodium linear alkylbenzenesulfonate (manufactured by Fujifilm Wako Pure Chemical Industries, Ltd.) were mixed with 385 parts of ion-exchanged water and dispersed for about 1 h using a wet jet mill JN100 (manufactured by Jokou Co., Ltd.) to obtain release agent-dispersed solution 1. The concentration of release agent-dispersed solution 1 was 20% by mass.

### Preparation of Colorant-Dispersed Solution 1

A total of 100 parts of carbon black “Nipex 35 (manufactured by Orion Engineered Carbons Co., Ltd.)” as a colorant, and 15.0 parts of sodium linear alkylbenzenesulfonate (manufactured by Fujifilm Wako Pure Chemical Industries, Ltd.) were mixed with 885 parts of ion-exchanged water and dispersed for about 1 h using a wet jet mill JN100 to obtain colorant-dispersed solution 1.

### Preparation Example of Toner Core Particle-Dispersed Solution 1

### Dispersion Step

A total of 265 parts of resin particle-dispersed solution 1, 10 parts of release agent-dispersed solution 1, 10 parts of colorant-dispersed solution 1, and 3.0 parts of sodium linear alkylbenzenesulfonate (manufactured by Fujifilm Wako Pure Chemical Industries, Ltd.) were mixed and dispersed using a homogenizer (Ultra Turrax T50, manufactured by IKA Corporation). The temperature inside the container was adjusted to 30° C. while stirring, and a 1 mol/L aqueous solution of sodium hydroxide was added to adjust the pH to 8.0.

### Aggregation Step

An aqueous solution obtained by dissolving 0.08 parts of aluminum chloride in 10 parts of ion-exchanged water was added as an aggregating agent over a period of 10 min at 30° C. while stirring. After allowing the system to stand for 3 min, the temperature was raised to 50° C. to generate associated particles. In this state, the particle diameter of the associated particles was measured using a Coulter Counter Multisizer 3 (registered trademark, manufactured by Beckman Coulter, Inc.). When the weight-average particle diameter reached 7.0 μm, 0.9 parts of sodium chloride and 5.0 parts of sodium linear alkylbenzene sodium sulfonate (manufactured by Fujifilm Wako Pure Chemical Industries, Ltd.) were added to stop particle growth.

The pH was adjusted to 9.0 by adding 1 mol/L of sodium hydroxide aqueous solution, and the temperature was then raised to 95° C. to spheroidize the aggregated particles. Once the average circularity has reached 0.980, the temperature lowering process was started and the mixture was cooled to room temperature to obtain toner particle-dispersed solution 1.

The obtained toner particle-dispersed solution 1 was added with hydrochloric acid to adjust the pH to not more than 1.5, and the mixture was allowed to stand for 1 h under stirring and then subjected to solid-liquid separation using a pressure filter to obtain a toner cake. This was reslurried with ion-exchanged water to make a dispersion liquid again, and then subjected to solid-liquid separation using the aforementioned filter. The reslurrying and solid-liquid separation were repeated until the electrical conductivity of the filtrate became not more than 5.0 μS/cm, and then solid-liquid separation was finally performed to obtain a toner cake. The obtained toner cake was dried and further classified using a classifier to obtain toner core particles 1. The number-average particle diameter of the primary particles of toner core particles 1 was 6.9 μm. In addition, the glass transition temperature Tg of toner core particles 1 was measured and found to be 56° C.

### Production Example of Amorphous Polyester Resin 1

| | | |
|---|---|---|
| Bisphenol A propylene oxide 2-mol adduct | 100 | mol parts |
| Terephthalic acid | 50 | mol parts |
| Fumaric acid | 30 | mol parts |
| n-Dodecenyl succinic acid | 25 | mol parts |

The above monomers were charged into a flask equipped with a stirrer, a nitrogen inlet tube, a temperature sensor, and a distillation column, the temperature was raised to 195° C. in 1 h, and it was confirmed that the reaction system was stirred uniformly. A total of 1.0 part of tin distearate was added to a total of 100 parts of these monomers. The temperature was then raised from 195° C. to 250° C. over 5 h while distilling off the water produced, and a dehydration condensation reaction was carried out at 250° C. for another 2 h to obtain amorphous polyester resin 1.

### Production Example of Toner Core Particles 2

| | | |
|---|---|---|
| Amorphous polyester resin 1: | 100 | parts by mass |
| Nipex 35 (manufactured by Orion | 9 | parts by mass |
| Engineered Carbons Co., Ltd.): | | |
| Fischer-Tropsch wax (C105, | 3 | parts by mass |
| manufactured by Sasol Corporation): | | |
| Charge control agent (T-77, manufactured | 2 | parts by mass |

by Hodogaya Chemical Co., Ltd.):

The above materials were premixed in a Henschel mixer, and then melt-kneaded using a twin-screw extruder (product name: PCM-30, manufactured by Ikegai Iron Works Co., Ltd.) with the temperature set so that the melt temperature at the discharge port was 150° C.

The resulting kneaded material was cooled, coarsely pulverized with a hammer mill, and then finely pulverized with a pulverizer (product name: Turbo Mill T250, manufactured by Turbo Kogyo Co., Ltd.). The finely pulverized powder obtained was classified using a multi-division classifier utilizing the Coanda effect to obtain toner core particles 2 with a weight-average particle diameter (D4) of 7.0 μm.

### Production Example of Strontium Titanate Fine Particles 1

Metatitanic acid produced by the sulfuric acid method was treated to remove iron and bleached, and then 3 mol/L aqueous sodium hydroxide solution was added to adjust the pH to 9.0, followed by desulfurization, neutralization to pH 5.6 with 5 mol/L hydrochloric acid, filtration and washing with water. Water was added to the washed cake to make a slurry of 1.90 mol/L based on the molar basis of TiO₂, and hydrochloric acid was added to adjust the pH to 1.4, followed by peptization.

A total of 1.90 mol (based on the molar basis of TiO₂) of the desulfurized and peptized metatitanic acid was collected and placed in a 3 L reaction vessel. A total of 2.185 mol of strontium chloride aqueous solution was added to the peptized metatitanic acid slurry to make the SrO/TiO₂ (molar ratio) 1.15, and the TiO₂ concentration was adjusted to 1.039 mol/L.

Next, a sodium silicate aqueous solution was prepared so that the amount of silicon added was equivalent to 3.0 mol % relative to strontium, and after heating to 90° C. under stirring and mixing, 440 mL of a 10 mol/L aqueous sodium hydroxide solution was added over 55 min under ultrasonic vibration. After continuing stirring at 95° C. for 45 min, the mixture was poured into ice water and rapidly cooled to terminate the reaction.

The reaction slurry was heated to 70° C., 12 mol/L hydrochloric acid was added until the pH reached 5.0, and stirring was continued for 1 h. The resulting precipitate was washed by decantation. After separation by filtration, drying was performed in the air at 120° C. for 8 h. Next, 300 g of the dried product was placed in a dry particle composing device (Nobilta NOB-130, manufactured by Hosokawa Micron Corporation). Treatment was performed for 10 min at a treatment temperature of 30° C. with a rotary treatment blade at 90 m/sec. Hydrochloric acid was further added to the dried product until the pH reached 0.1, and stirring was continued for 1 h. The obtained precipitate was washed by decantation. The slurry containing the precipitate was adjusted to 40° C., and hydrochloric acid was added to adjust the pH to 2.5.

Next, 12% by mass (based on the solid content) of isobutyltrimethoxysilane was added as a surface treatment agent after stirring and mixing for 1 h, and stirring was continued for 10 h. The surface treatment of the strontium titanate fine particles was performed by adding 5N sodium hydroxide solution to adjust the pH to 6.5, continuing stirring for 1 h, then filtering and washing, and drying the resulting cake in the air at 120° C. for 8 h. The obtained strontium titanate fine particles were taken as strontium titanate fine particles 1. The physical properties of the obtained strontium titanate fine particles are shown in Table 1.

### Production Example of Strontium Titanate Fine Particles 2 to 10

Strontium titanate fine particles 2 to 10 were obtained by changing the amount of silicon added, the surface treatment components and the amount added as shown in Table 1 and adjusting, as appropriate, the addition rate of “440 mL of 10 mol/L sodium hydroxide aqueous solution”, the stirring conditions, the ultrasonic dispersion conditions, and the processing time by using the dry particle composing device in the production example of strontium titanate fine particles 1. The physical properties of the obtained strontium titanate fine particles 2 to 10 are shown in Table 1.

TABLE 1

| | Addition of Si | Surface treatment | | Number-average | Powder | |
|---|---|---|---|---|---|---|
| | Amount of Si added | | Treatment | particle diameter of | resistivity R_{A} | |
| | [mol %] | Surface treatment agent | amount [wt %] | primary particles [nm] | [μΩ · cm] | Si/Sr |
| Strontium titanate fine | 3 | Isobutyltrimethoxysilane | 12 | 40 | 2.9.E+09 | 0.26 |
| particles 1 | | | | | | |
| Strontium titanate fine | — | Isobutyltrimethoxysilane | 5 | 40 | 4.7.E+09 | 0.18 |
| particles 2 | | | | | | |
| Strontium titanate fine | 2 | Isobutyltrimethoxysilane | 5 | 38 | 1.2.E+08 | 0.20 |
| particles 3 | | | | | | |
| Strontium titanate fine | 8 | Isobutyltrimethoxysilane | 25 | 50 | 9.7.E+11 | 0.59 |
| particles 4 | | | | | | |
| Strontium titanate fine | 8 | Isobutyltrimethoxysilane | 28 | 50 | 9.9.E+11 | 0.63 |
| particles 5 | | | | | | |
| Strontium titanate fine | 7 | Isobutyltrimethoxysilane | 17 | 15 | 9.7.E+09 | 0.38 |
| particles 6 | | | | | | |
| Strontium titanate fine | 7 | Isobutyltrimethoxysilane | 15 | 25 | 4.0.E+09 | 0.38 |
| particles 7 | | | | | | |
| Strontium titanate fine | 3 | Isobutyltrimethoxysilane | 6 | 80 | 1.9.E+09 | 0.26 |
| particles 8 | | | | | | |
| Strontium titanate fine | 3 | Isobutyltrimethoxysilane | 5 | 100 | 1.5.E+09 | 0.26 |
| particles 9 | | | | | | |
| Strontium titanate fine | — | — | — | 37 | 3.2.E+06 | 0.00 |
| particles 10 | | | | | | |

In the table, for example, the notation “2.9E+09” means 2.9×10⁹.

### Production Example of Titanium Oxide Fine Particles

Ilmenite ore containing 50% by mass of TiO₂ equivalent was dried at 150° C. for 3 h, and then sulfuric acid was added to dissolve the ore, thereby obtaining an aqueous solution of TiOSO₄. The obtained aqueous solution was concentrated, 10 parts of titania sol having rutile crystals was added as seeds, and hydrolysis was performed at 170° C. to obtain a slurry of TiO(OH)₂ containing impurities. This slurry was repeatedly washed at pH 5 to 6 to sufficiently remove sulfuric acid, FeSO₄, and impurities, thereby obtaining a slurry of high-purity metatitanic acid [TiO(OH)₂]. This slurry was filtered, 0.5 parts of lithium carbonate (Li₂CO₃) was added, and the mixture was baked at 250° C. for 3 h, and then repeatedly pulverizes using a jet mill to obtain titanium oxide fine particles having rutile crystals. The obtained titanium oxide fine particles were dispersed in ethanol and stirred, while 5 parts of isobutyltrimethoxysilane was added dropwise as a surface treatment agent to 100 parts of titanium oxide fine particles and reacted. After drying, heating was performed at 170° C. for 3 h, followed by repeated pulverization with a jet mill until no titanium oxide aggregates remained. As a result, titanium oxide fine particles were obtained.

The powder resistivity R_{B} of the obtained titanium oxide fine particles was 1.3×10⁸ μΩ cm. The number-average particle diameter of the primary particles was 25 nm.

Next, production examples of toner will be described.

### Production Example of Toner 1

### First Step

A total of 0.50 parts of titanium oxide fine particles were added to 100 parts of toner particle-dispersed solution 1, and the components were stirred for 30 min at a rotation speed of 50 (rev/s) using “Clearmix” (manufactured by M Technique Co., Ltd.) to uniformly disperse the toner particles and titanium oxide fine particles.

### Wet Method Step (1)

Then, the dispersion liquid was heated to 60° C., and while maintaining the temperature at 60° C., the aforementioned Clearmix was used to stir the liquid at a rotation speed of 70 (rev/s) for 60 min, thereby causing adhesion of the titanium oxide fine particles to the toner particle surface.

### Wet Method Step (2)

Then, the rotation speed of aforementioned Clearmix was set to 30 (rev/s), and the temperature of the stirring tank was raised to 80° C. and maintained for 60 min, to obtain a toner-dispersed solution. Hydrochloric acid was added to the obtained toner-dispersed solution to adjust the pH to not more than 1.5, and the liquid was allowed to stand under stirring for 1 h, followed by solid-liquid separation using a pressure filter to obtain a toner cake. This was reslurried with ion-exchanged water to make a dispersion liquid again, and then solid-liquid separation was carried out using the aforementioned filter. The reslurrying and solid-liquid separation were repeated until the electrical conductivity of the filtrate became not more than 5.0 μS/cm, and finally the solid-liquid separation was performed to obtain a toner cake. The obtained toner cake was dried and further classified using a classifier to obtain toner precursor particles 1.

### Second Step

A total of 100 parts of the obtained toner precursor particles 1 and 0.60 parts of strontium titanate fine particles 1 were put into an FM mixer (FM10C type, manufactured by Nippon Coke & Engineering Co., Ltd.) in which water at 7° C. was passing through the jacket. After the water temperature in the jacket stabilized at 7° C.±1° C., the components were mixed for 5 min at a rotating blade peripheral speed of 20 m/sec to obtain toner mixture 1. At this time, the amount of water passing through the jacket was adjusted, as appropriate, so that the temperature inside the FM mixer tank did not exceed 25° C. The obtained toner mixture 1 was sieved through a mesh with an opening of 75 μm to obtain toner 1.

The physical properties of the obtained toner 1 are shown in Table 3.

### Production Example of Toner 2

### First Step

A total of 100 parts of the obtained toner core particles 1 and 0.50 parts of titanium oxide fine particles were put into an FM mixer (FM10C type, manufactured by Nippon Coke & Engineering Co., Ltd.) in which water at 53° C. was passing through the jacket. After confirming that the water temperature in the jacket was stable at 53° C.±1° C. and the temperature in the tank was stable at 53° C.±1° C., the components were mixed for 5 min at a rotating blade peripheral speed of 35 m/sec. At this time, the amount of water passing through the jacket was adjusted, as appropriate, so that the temperature in the FM mixer tank was stable at 53° C.±1° C. After mixing was completed, the water temperature in the jacket was set to 25° C., it was confirmed that the temperature in the tank was stable at 25° C., and the second step was started.

### Second Step

After confirming that the temperature inside the tank had stabilized at 25° C., 0.60 parts of strontium titanate fine particles 1 were added to the FM mixer. The water passing through the jacket was set to 7° C., and once the water temperature inside the jacket had stabilized at 7° C.±1° C., the components were mixed for 5 min at a rotating blade peripheral speed of 20 m/sec, yielding toner mixture 2. At this time, the amount of water passing through the jacket was adjusted, as appropriate, so that the temperature inside the FM mixer tank did not exceed 25° C. The resulting toner mixture 2 was sieved through a mesh with 75 μm openings to obtain toner 2.

The physical properties of the toner 2 are shown in Table 3.

### Production Examples of Toners 3 to 11, 13, and 16 to 21 and Comparative Toners 3 to 5

Toners 3 to 11, 13, and 16 to 21 and comparative toners 3 to 5 were obtained in the same manner as in the production example of toner 1, except that the number of parts, material type, and production conditions were changed as shown in Table 2. The physical properties of the obtained toners 3 to 11, 13, 16 to 21 and comparative toners 3 to 5 are shown in Table 3.

### Production Examples of Toners 12, 14 and 15, and Comparative Toners 1 and 2

Toners 12, 14 and 15, and comparative toners 1 and 2 were obtained in the same manner as in the production example of toner 2, except that the number of parts, material type, and production conditions were changed as shown in Table 2.

The physical properties of the obtained toners 12, 14 and 15, and comparative toners 1 and 2 are shown in Table 3.

### Production Example of Toner 22

Toner 22 was obtained in the same manner as in the production example of toner 2, except that toner core particle 2 was used instead of toner core particle 1 and the number of parts, material type, and production conditions were changed as shown in Table 2.

The physical properties of the obtained toner 22 are shown in Table 3.

TABLE 2

| | | First step | | | | | | | |
|---|---|---|---|---|---|---|---|---|---|
| | | | Number | | Number | | | | |
| | | | of parts | | of parts | | | | |
| | mixing | Added | added | Added | added | Wet method conditions | | | |
| Toner | device | particles 1 | [parts] | particles 2 | [parts] | Rs(1) | Temp(1) | Rs(2) | Temp(2) |
| Toner 1 | Wet | Titanium oxide | 0.50 | — | — | 70 | 60 | 30 | 80 |
| | method | fine particles | | | | | | | |
| Toner 2 | Fm | Titanium oxide | 0.50 | — | — | — | — | — | — |
| | mixer | fine particles | | | | | | | |
| Toner 3 | Wet | Titanium oxide | 0.10 | — | — | 70 | 60 | 30 | 80 |
| | method | fine particles | | | | | | | |
| Toner 4 | Wet | Titanium oxide | 1.00 | — | — | 70 | 60 | 30 | 80 |
| | method | fine particles | | | | | | | |
| Toner 5 | Wet | Titanium oxide | 0.50 | — | — | 70 | 60 | 30 | 80 |
| | method | fine particles | | | | | | | |
| Toner 6 | Wet | Titanium oxide | 0.50 | — | — | 70 | 60 | 30 | 80 |
| | method | fine particles | | | | | | | |
| Toner 7 | Wet | Titanium oxide | 1.05 | — | — | 70 | 60 | 30 | 80 |
| | method | fine particles | | | | | | | |
| Toner 8 | Wet | Titanium oxide | 0.50 | — | — | 70 | 60 | 30 | 80 |
| | method | fine particles | | | | | | | |
| Toner 9 | Wet | Titanium oxide | 0.50 | — | — | 70 | 60 | 30 | 80 |
| | method | fine particles | | | | | | | |
| Toner 10 | Wet | Titanium oxide | 0.50 | — | — | 70 | 60 | 30 | 80 |
| | method | fine particles | | | | | | | |
| Toner 11 | Wet | Titanium oxide | 0.50 | — | — | 70 | 60 | 30 | 80 |
| | method | fine particles | | | | | | | |
| Toner 12 | Fm | Strontium | 0.60 | — | — | — | — | — | — |
| | mixer | titanate fine | | | | | | | |
| | | particles 1 | | | | | | | |
| Toner 13 | Wet | Titanium oxide | 0.50 | — | — | 70 | 60 | 30 | 80 |
| | method | fine particles | | | | | | | |
| Toner 14 | Fm | Titanium oxide | 0.50 | Strontium | 0.60 | — | — | — | — |
| | mixer | fine particles | | titanate fine | | | | | |
| | | | | particles 1 | | | | | |
| Toner 15 | Fm | Titanium oxide | 0.50 | Strontium | 0.60 | — | — | — | — |
| | mixer | fine particles | | titanate fine | | | | | |
| | | | | particles 1 | | | | | |
| Toner 16 | Wet | Titanium oxide | 0.50 | — | — | 60 | 60 | 30 | 80 |
| | method | fine particles | | | | | | | |
| Toner 17 | Wet | Titanium oxide | 0.50 | — | — | 50 | 60 | 30 | 80 |
| | method | fine particles | | | | | | | |
| Toner 18 | Wet | Titanium oxide | 0.50 | — | — | 70 | 60 | 30 | 80 |
| | method | fine particles | | | | | | | |
| Toner 19 | Wet | Titanium oxide | 0.50 | — | — | 70 | 60 | 30 | 80 |
| | method | fine particles | | | | | | | |
| Toner 20 | Wet | Titanium oxide | 0.50 | — | — | 70 | 60 | 30 | 80 |
| | method | fine particles | | | | | | | |
| Toner 21 | Wet | Titanium oxide | 0.50 | — | — | 70 | 60 | 30 | 80 |
| | method | fine particles | | | | | | | |
| Toner 22 | Fm | Titanium oxide | 0.50 | — | — | — | — | — | — |
| | mixier | fine particles | | | | | | | |
| Comparative | Fm | Strontium | 0.60 | — | — | — | — | — | — |
| Toner 1 | mixier | titanate fine | | | | | | | |
| | | particles 1 | | | | | | | |
| Comparative | Fm | Titanium oxide | 0.50 | — | — | — | — | — | — |
| Toner 2 | mixier | fine particles | | | | | | | |
| Comparative | Wet | Titanium oxide | 0.50 | — | — | 70 | 60 | 30 | 80 |
| Toner 3 | method | fine particles | | | | | | | |
| Comparative | Wet | Titanium oxide | 0.05 | — | — | 70 | 60 | 30 | 80 |
| Toner 4 | method | fine particles | | | | | | | |
| Comparative | Wet | Titanium oxide | 0.50 | — | — | — | — | — | — |
| Toner 5 | method | fine particles | | | | | | | |

| | First step | | | | | |
|---|---|---|---|---|---|---|
| | Dry method | | Second step | | | |
| | conditions | | | Number | | |
| | | Temperature | | of parts | | Temperature |
| | mixing | in tank | | added | mixing | in tank |
| Toner | conditions | [° C.] | Added particles | [parts] | conditions | [° C.] |
| Toner 1 | — | — | Strontium titanate | 0.60 | 20 (m/s)/ | 25 |
| | | | fine particles 1 | | 5 min | |
| Toner 2 | 35 (m/s)/ | 53 | Strontium titanate | 0.60 | 20 (m/s)/ | 25 |
| | 5 min | | fine particles 1 | | 5 min | |
| Toner 3 | — | — | Strontium titanate | 0.10 | 20 (m/s)/ | 25 |
| | | | fine particles 1 | | 5 min | |
| Toner 4 | — | — | Strontium titanate | 1.50 | 20 (m/s)/ | 25 |
| | | | fine particles 1 | | 5 min | |
| Toner 5 | — | — | Strontium titanate | 0.60 | 20 (m/s)/ | 25 |
| | | | fine particles 1 | | 5 min | |
| Toner 6 | — | — | Strontium titanate | 0.60 | 20 (m/s)/ | 25 |
| | | | fine particles 1 | | 5 min | |
| Toner 7 | — | — | Strontium titanate | 2.50 | 20 (m/s)/ | 25 |
| | | | fine particles 1 | | 5 min | |
| Toner 8 | — | — | Strontium titanate | 0.60 | 20 (m/s)/ | 25 |
| | | | fine particles 2 | | 5 min | |
| Toner 9 | — | — | Strontium titanate | 0.60 | 20 (m/s)/ | 25 |
| | | | fine particles 3 | | 5 min | |
| Toner 10 | — | — | Strontium titanate | 0.60 | 20 (m/s)/ | 25 |
| | | | fine particles 4 | | 5 min | |
| Toner 11 | — | — | Strontium titanate | 0.60 | 20 (m/s)/ | 25 |
| | | | fine particles 5 | | 5 min | |
| Toner 12 | 35 (m/s)/ | 53 | Titanium oxide | 0.50 | 35 (m/s)/ | 53 |
| | 5 min | | fine particles | | 5 min | |
| Toner 13 | — | — | Strontium titanate | 0.60 | 20 (m/s)/ | 25 |
| | | | fine particles 1 | | 5 min | |
| Toner 14 | 35 (m/s)/ | 53 | — | — | — | — |
| | 5 min | | | | | |
| Toner 15 | 38 (m/s)/ | 53 | — | — | — | — |
| | 6 min | | | | | |
| Toner 16 | — | — | Strontium titanate | 0.60 | 20 (m/s)/ | 25 |
| | | | fine particles 1 | | 5 min | |
| Toner 17 | — | — | Strontium titanate | 0.60 | 20 (m/s)/ | 25 |
| | | | fine particles 1 | | 5 min | |
| Toner 18 | — | — | Strontium titanate | 0.60 | 20 (m/s)/ | 25 |
| | | | fine particles 6 | | 5 min | |
| Toner 19 | — | — | Strontium titanate | 0.60 | 20 (m/s)/ | 25 |
| | | | fine particles 7 | | 5 min | |
| Toner 20 | — | — | Strontium titanate | 0.60 | 20 (m/s)/ | 25 |
| | | | fine particles 8 | | 5 min | |
| Toner 21 | — | — | Strontium titanate | 0.60 | 20 (m/s)/ | 25 |
| | | | fine particles 9 | | 5 min | |
| Toner 22 | 35 (m/s)/ | 53 | Strontium titanate | 0.60 | 20 (m/s)/ | 25 |
| | 5 min | | fine particles 1 | | 5 min | |
| Comparative | 20 (m/s)/ | 25 | — | — | — | — |
| Toner 1 | 5 min | | | | | |
| Comparative | 5 (m/s)/ | 53 | — | — | — | — |
| Toner 2 | 5 min | | | | | |
| Comparative | — | — | Strontium titanate | 0.60 | 20 (m/s)/ | 25 |
| Toner 3 | | | fine particles 10 | | 5 min | |
| Comparative | — | — | Strontium titanate | 0.25 | 20 (m/s)/ | 25 |
| Toner 4 | | | fine particles 1 | | 5 min | |
| Comparative | 20 (m/s)/ | 25 | Strontium titanate | 0.60 | 20 (m/s)/ | 25 |
| Toner 5 | 5 min | | fine particles 1 | | 5 min | |

In Table 2, “Rs(1)” represents “Wet method step (1) Rotation speed [rev/s]”, “Temp(1)” represents “Wet method step (1) Temperature [° C.]”, “Rs(2)” represents “Wet method step (2) Rotation speed [rev/s]”, and “Temp(2)” represents “Wet method step (2) Temperature [° C.]”, respectively.

TABLE 3

| | | Water washing | Water washing | | | | |
|---|---|---|---|---|---|---|---|
| | Dispersion | method adhesion | method adhesion | | | | |
| | evaluation index of | rate α of strontium | rate β of titanium | | | | |
| | titanium oxide fine | titanate fine | oxide fine | | | | |
| Toner | particles | particles | particles | α/β | A/(A + B) | C | C/{A/(A + B)} |
| Toner 1 | 0.3 | 15% | 61% | 0.25 | 0.68 | 0.05 | 0.07 |
| Toner 2 | 0.4 | 15% | 57% | 0.26 | 0.68 | 0.04 | 0.06 |
| Toner 3 | 0.4 | 15% | 72% | 0.21 | 0.69 | 0.17 | 0.25 |
| Toner 4 | 0.4 | 15% | 48% | 0.31 | 0.68 | 0.14 | 0.20 |
| Toner 5 | 0.3 | 15% | 31% | 0.48 | 0.51 | 0.06 | 0.11 |
| Toner 6 | 0.3 | 15% | 92% | 0.16 | 0.96 | 0.11 | 0.11 |
| Toner 7 | 0.3 | 15% | 61% | 0.25 | 0.87 | 0.19 | 0.22 |
| Toner 8 | 0.3 | 15% | 61% | 0.25 | 0.66 | 0.07 | 0.10 |
| Toner 9 | 0.3 | 15% | 61% | 0.25 | 0.69 | 0.09 | 0.13 |
| Toner 10 | 0.3 | 15% | 61% | 0.25 | 0.67 | 0.06 | 0.09 |
| Toner 11 | 0.3 | 15% | 61% | 0.25 | 0.66 | 0.07 | 0.11 |
| Toner 12 | 0.3 | 60% | 55% | 1.09 | 0.50 | 0.10 | 0.19 |
| Toner 13 | 0.3 | 0% | 61% | 0.00 | 0.66 | 0.10 | 0.15 |
| Toner 14 | 0.3 | 40% | 53% | 0.75 | 0.51 | 0.10 | 0.20 |
| Toner 15 | 0.3 | 67% | 86% | 0.78 | 0.51 | 0.12 | 0.23 |
| Toner 16 | 0.5 | 15% | 61% | 0.25 | 0.53 | 0.13 | 0.25 |
| Toner 17 | 0.4 | 15% | 61% | 0.25 | 0.56 | 0.11 | 0.20 |
| Toner 18 | 0.3 | 15% | 61% | 0.25 | 0.62 | 0.06 | 0.10 |
| Toner 19 | 0.3 | 15% | 61% | 0.25 | 0.64 | 0.08 | 0.12 |
| Toner 20 | 0.3 | 15% | 61% | 0.25 | 0.62 | 0.06 | 0.09 |
| Toner 21 | 0.3 | 15% | 61% | 0.25 | 0.64 | 0.06 | 0.10 |
| Toner 22 | 0.4 | 15% | 59% | 0.25 | 0.68 | 0.05 | 0.07 |
| Comparative Toner 1 | — | 15% | — | — | — | — | 0.10 |
| Comparative Toner 2 | 0.3 | — | 61% | 0.00 | 0.67 | 0.07 | 0.11 |
| Comparative Toner 3 | 0.3 | 15% | 61% | 0.25 | 0.67 | 0.07 | 0.26 |
| Comparative Toner 4 | 0.3 | 15% | 79% | 0.19 | 0.53 | 0.14 | 0.27 |
| Comparative Toner 5 | 0.3 | 15% | 28% | 0.54 | 0.45 | 0.12 | |

### Example 1

As an electrophotographic apparatus, an HP Color Laser jet Enterprise M653dn (product name, manufactured by HP Co.) was prepared. Next, a process cartridge in which toner 1 was filled in a specified cartridge and the electrophotographic apparatus were allowed to stand in a high-temperature and high-humidity environment (32.5° C./80% RH) for 48 h in order to acclimate them to the measurement environment.

The process cartridge allowed to stand in the above environment was set in the M653dn and evaluated.

The M653dn used was modified to have a process speed of 410 mm/s in consideration of further increase in speed and extension of service life of printers in the future. A4 paper (product name: “GF-0081”, 81.4 g/m², manufactured by Canon Inc.) was used as the evaluation paper.

### Evaluation of Initial Charge Quantity

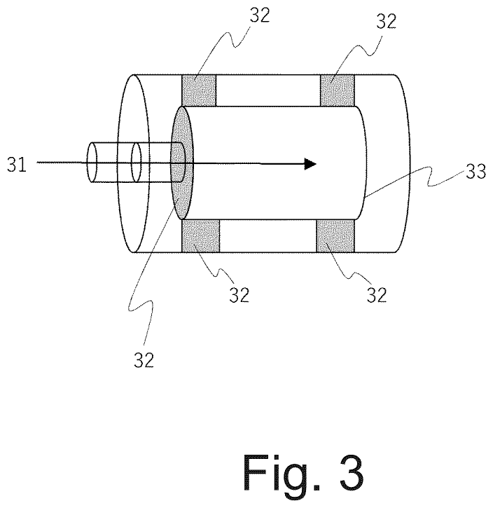

The initial charge quantity was measured by outputting 10 solid images using the electrophotographic apparatus allowed to stand in the above environment, forcibly stopping the machine during the output of the 10th sheet, and measuring the toner charge quantity on the developing roller immediately after it passed through the control member. The charge quantity on the developing roller was measured using a Faraday cage shown in the perspective view of FIG. 3. The inside (right side of the figure) was reduced in pressure so that the toner on the carrier member was sucked in, and a toner filter 33 was provided to collect the toner. The reference numeral 31 stands for a suction part, and the reference numeral 32 stands for a holder. The charge quantity per unit mass, Q/M (μC/g), was calculated from the mass M of the collected toner and the charge Q measured directly with a coulomb meter, and the toner charge quantity (Q/M) was ranked as follows. In this evaluation, the higher the value, the higher the charge quantity. The evaluation results are shown in Table 4.
A: Toner charge quantity on the developing roller is at least 50 μC/g
B: Toner charge quantity on the developing roller is at least 40 μC/g but less than 50 μC/g
C: Toner charge quantity on the developing roller is at least 30 μC/g but less than 40 μC/g
D: Toner charge quantity on the developing roller is less than 30 μC/g Evaluation of Toner Flowability

Toner flowability was evaluated by checking solid images. With the machine allowed to stand in the aforementioned environment, ten all-solid images were output on A4 paper (product name: “GF-0081”, 81.4 g/m², manufactured by Canon Inc.) and the difference in image density between the leading edge of the first all-solid image and the trailing edge of the tenth all-solid image was checked to perform an initial evaluation.

Next, for the post-durability evaluation, a horizontal line pattern with a print percentage of 1% was set to two sheets per job, and the machine was set to stop between jobs before starting the next job. A total of 30,000 images were output in this mode. After that, ten all-solid images were output in the same manner as in the initial evaluation, and the toner flowability after durability was evaluated. The evaluation criteria are as described below. The evaluation results are shown in Table 4.

In both the initial evaluation and the post-durability evaluation, the evaluation was performed based on the difference in image density between the leading edge of the first all-solid image and the trailing edge of the tenth all-solid image.
A: The difference between the image density of the leading edge of the first solid image and the image density of the trailing edge of the tenth solid image is less than 0.10.
B: The difference between the image density of the leading edge of the first solid image and the image density of the trailing edge of the tenth solid image is at least 0.10 and less than 0.20.
C: The difference between the image density of the leading edge of the first solid image and the image density of the trailing edge of the tenth solid image is at least 0.20 and less than 0.30.
D: The difference between the image density of the leading edge of the first solid image and the image density of the trailing edge of the tenth solid image is at least 0.30.

The image density was measured using a Macbeth Reflection Densitometer RD918 (manufactured by Macbeth Co.) according to the instruction manual provided with the densitometer, by measuring the relative density against the image of the white background with an image density of 0.00. The obtained relative density was taken as the image density value. The following evaluations are the same.

### Evaluation of Charge Uniformity

The charge uniformity was evaluated by checking the fogging amount on the photosensitive drum. The fogging on the photosensitive drum was measured using REFLECTMETER MODEL TC-6DS manufactured by Tokyo Denshoku Co., Ltd. A green filter was used.

The evaluation was performed after evaluating the toner flowability after durability in the machine that was allowed to stand in the abovementioned environment. In the evaluation, the photosensitive drum was taped with a Mylar tape for a white image immediately after outputting a solid black image, and the reflectance of the image pasted with the Mylar tape on paper was measured. The reflectance of the Mylar tape pasted directly on the paper was subtracted from the measured reflectance to calculate the fogging (%) on the photosensitive drum, and the evaluation was performed according to the following criteria. The evaluation results are shown in Table 4.

Fogging on the photosensitive drum (reflectance) (%)=reflectance of the tape taped on the drum (%)−reflectance of the tape pasted directly on the paper (%)
A: Fogging on the photosensitive drum is less than 0.5%.
B: Fogging on the photosensitive drum is at least 0.5% and less than 1.0%.
C: Fogging on the photosensitive drum is at least 1.0% and less than 2.0%.
D: Fogging on the photosensitive drum is at least 2.0%.

### Evaluation of Charge Rising Performance

After the charge uniformity evaluation, 100 images with a print percentage of 1% were output. Then, the machine was allowed to stand for another 48 h in a high-temperature and high-humidity environment (32.5° C./80% RH). Then, ten images for checking the density (solid images) were printed consecutively, the image density was checked and an initial evaluation was performed.

Regarding the charge rising performance after durability, after the charge uniformity evaluation after durability, 100 images with a print percentage of 1% were printed. Then, the machine was allowed to stand for another 48 h in a high-temperature and high-humidity environment (32.5° C./80% RH). After that, ten density check images (solid images) were printed in succession to check the image density. The evaluation results are shown in Table 4.
A: The image density of at least 1.30 was obtained from the first sheet.
B: The image density of at least 1.30 was obtained from the second and third sheets.
C: The image density of at least 1.30 was obtained from the fourth to tenth sheets.
D: The image density was less than 1.30 even on the tenth sheet.

### Examples 2 to 21, Comparative Examples 1 to 5

The evaluation was performed in the same manner as in Example 1, except for changing the toner to be filled as shown in Table 4. The evaluation results are shown in Table 4.

TABLE 4

| | | | | | | | | Charge uniformity | | Charge rising performance | |
|---|---|---|---|---|---|---|---|---|---|---|---|
| | | Charge quantity under | | Flowability under high temperature | | | | under high temperature | | under high temperature and | |
| | | high temperature and | | and high humidity | | | | and high humidity | | high humidity | |
| | | high humidity | | | | Density | | Fogging | | | Density |
| | | Charge | | Initial | Initial | difference | Evaluation | amount after | | Initial | difference |
| | | quantity | Evalua- | density | evalua- | after | after | durability | Evalua- | evalua- | after |
| Example | Toner | [μC] | tion | difference | tion | durability | durability | [%] | tion | tion | durability |
| Example 1 | Toner 1 | 55 | A | 0.02 | A | 0.05 | A | 0.2 | A | A | A |
| Example 2 | Toner 2 | 53 | A | 0.04 | A | 0.08 | A | 0.4 | A | A | A |
| Example 3 | Toner 3 | 53 | A | 0.03 | A | 0.16 | B | 0.7 | B | B | B |
| Example 4 | Toner 4 | 42 | B | 0.02 | A | 0.06 | A | 0.3 | A | B | B |
| Example 5 | Toner 5 | 42 | B | 0.11 | B | 0.18 | B | 0.6 | B | B | B |
| Example 6 | Toner 6 | 46 | B | 0.05 | A | 0.13 | B | 0.8 | B | A | B |
| Example 7 | Toner 7 | 41 | B | 0.03 | A | 0.0.6 | B | 0.4 | B | B | B |
| Example 8 | Toner 8 | 42 | B | 0.07 | A | 0.09 | A | 0.8 | B | B | B |
| Example 9 | Toner 9 | 49 | B | 0.05 | A | 0.08 | A | 0.4 | A | A | B |
| Example 10 | Toner 10 | 53 | A | 0.05 | A | 0.12 | B | 0.4 | A | A | B |
| Example 11 | Toner 11 | 51 | A | 0.09 | A | 0.18 | B | 0.8 | B | B | B |
| Example 12 | Toner 12 | 44 | B | 0.09 | A | 0.19 | B | 0.9 | B | B | B |
| Example 13 | Toner 13 | 49 | B | 0.02 | A | 0.12 | B | 0.8 | B | B | B |
| Example 14 | Toner 14 | 43 | B | 0.12 | B | 0.18 | B | 0.5 | B | A | B |
| Example 15 | Toner 15 | 41 | B | 0.15 | B | 0.19 | B | 0.8 | B | B | B |
| Example 16 | Toner 16 | 47 | B | 0.12 | B | 0.19 | B | 0.7 | B | B | B |
| Example 17 | Toner 17 | 48 | B | 0.08 | A | 0.17 | B | 0.4 | A | A | B |
| Example 18 | Toner 18 | 52 | A | 0.03 | A | 0.18 | B | 0.3 | A | A | B |
| Example 19 | Toner 19 | 54 | A | 0.03 | A | 0.18 | B | 0.2 | A | A | A |
| Example 20 | Toner 20 | 46 | B | 0.10 | B | 0.18 | B | 0.4 | A | A | B |
| Example 21 | Toner 21 | 43 | B | 0.14 | B | 0.19 | B | 0.7 | B | B | B |
| Example 22 | Toner 22 | 51 | A | 0.04 | A | 0.06 | A | 0.4 | A | A | A |
| Comparative | Comparative | 45 | B | 0.15 | B | — | D | 2.3 | D | D | D |
| example 1 | Toner 1 | | | | | | | | | | |
| Comparative | Comparative | 20 | D | 0.16 | B | 0.19 | B | 2.5 | D | D | D |
| example 2 | Toner 2 | | | | | | | | | | |
| Comparative | Comparative | 29 | D | 0.06 | A | 0.09 | A | 2.0 | D | D | D |
| example 3 | Toner 3 | | | | | | | | | | |
| Comparative | Comparative | 48 | B | 0.06 | A | 0.23 | C | 1.1 | C | C | C |
| example 4 | Toner 4 | | | | | | | | | | |
| Comparative | Comparative | 32 | C | — | D | — | D | 2.5 | D | D | D |
| example 5 | Toner 5 | | | | | | | | | | |

According to the present disclosure, a toner is provided that has high charge retention property and sharp charging characteristics even in a high-temperature and high-humidity environment, and can maintain a high charge rising performance even in a longer-life and higher-speed electrophotographic process. Furthermore, even in high-temperature and high-humidity environments, a toner is provided that is less prone to image defects caused by a decline in charging characteristics over a long lifespan and can achieve high image quality in longer-lasting, high-speed electrophotographic devices.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188009, filed Oct. 25, 2024, which is hereby incorporated by reference herein in its entirety.

What is claimed is:

1. A toner comprising:
a toner particle, wherein
the toner particle has at a surface thereof a titanium oxide fine particle and a strontium titanate fine particle,
the strontium titanate fine particle contains silicon,
a content of the titanium oxide fine particle is 0.10 to 3.00 parts by mass with respect to 100 parts by mass of the toner particle, and
in cross-sectional observation of the toner with a scanning transmission electron microscope, when a total area of the titanium oxide fine particle present on a contour of a cross section of the toner particle and within 30 nm inside the contour of the cross section of the toner particle is denoted by A (pixel), and a total area of the titanium oxide fine particle present outside the contour of the cross section of the toner particle is denoted by B (pixel), formula (1) is satisfied:
$$1. \geq A / ( A + B ) \geq 0 \text{.50} . \qquad ( 1 )$$

2. The toner according to claim 1, wherein the content of the titanium oxide fine particle is 0.10 to 1.00 parts by mass with respect to 100 parts by mass of the toner particle.

3. The toner according to claim 1, wherein in the strontium titanate fine particle, a value (Si/Sr) of the total mass of silicon atoms to the total mass of strontium atoms, as measured by X-ray fluorescence analysis, is 0.20 to 0.60.

4. The toner according to claim 1, wherein when a water washing method adhesion rate of the strontium titanate fine particle is denoted by α and a water washing method adhesion rate of the titanium oxide fine particle is denoted by β, β is 40 to 100%, and α and β satisfy α≤β.

5. The toner according to claim 4, wherein α and β satisfy formula (3):
$$0.75 \geq α / β \geq 0 \text{.00} . \qquad ( 3 )$$

6. The toner according to claim 1, wherein the titanium oxide fine particle is a rutile-type titanium oxide fine particle.

7. The toner according to claim 1, wherein a dispersion evaluation index of the titanium oxide fine particle is not more than 0.4.

8. The toner according to claim 1, wherein a number-average particle diameter of primary particles of the strontium titanate fine particle is 25 to 80 nm.

9. The toner according to claim 1, wherein, in cross-sectional observation of the toner with the scanning transmission electron microscope, when a standard deviation of A/(A+B) is denoted by C, formula (2) is satisfied:
$$0.22 \geq C / \{ A / ( A + B ) \} \geq 0 \text{.00} . \qquad ( 2 )$$
